(19) United States
(12) Patent Application Publication
(10) Pub. No.: US 2003/0148136 A1
(43) Pub. Date: Aug. 7, 2003

(54) Surface treated copper foil, electrodeposited copper foil with carrier, manufacture method for the electrodeposited copper foil with carrier, and copper clad laminate

(75) Inventors: Takuya Yamamoto, Ageo-shi (JP); Takashi Kataoka, Ageo-shi (JP); Yutaka Hirasawa, Ageo-shi (JP); Naotomi Takahashi, Ageo-shi (JP)

Correspondence Address: ROTHWELL, FIGG, ERNST & MANBECK, P.C., 1425 K STREET, N.W., SUITE 800, WASHINGTON, DC, 20005, US

(73) Assignee: Mitsui Mining & Smelting Co. Ltd.

(21) Appl. No.: 10/067,240

(22) Filed: Feb. 7, 2002

(51) Int. Cl. B32B 15/16

(52) U.S. Cl. 428/607; 428/687; 428/675; 428/935

(57) ABSTRACT

The purpose is to provide a surface treated copper foil and an electrodeposited copper foil with carrier to be employed for a copper clad laminate capable to be processed for simultaneous hole formation in the copper foil layer and a substrate resin layer using carbon dioxide gas laser. The purpose can be achieved by using a surface treated copper foil bearing a nickel layer or a cobalt layer with a prescribed thickness in one side of a copper foil or an electrodeposited copper foil with carrier provided with a nickel layer or a cobalt layer with a prescribed thickness between a carrier foil and an electrode posited copper foil layer. When a copper clad laminate is manufactured using these foils, the copper clad laminate is capable to be processed to easily and simultaneously form a hole in the copper foil layer and the substrate resin layer using carbon dioxide gas laser.

### FIELD OF THE INVENTION

The present invention relates to an electrodeposited copper foil, an electrodeposited copper foil with carrier, a manufacture method of the electrodeposited copper foil with carrier, and a laminated board using the electrodeposited copper foil with carrier.

### BACKGROUND ART

Recently, following the wide spread of cellular phones, mobile tools, notebook personal computers and the like, the preference stream for light weight, thin, short, and compact sizing and high density integration is accelerated. Consequently, in the field of printed circuit boards to be incorporated into these electronic appliances, a circuit to be formed has been required to be a fine pitch circuit from the similar point of view.

That a printed circuit board is required to be light weight, thin, short, and compact in the size means that a multilayered highly densified circuit is required. Hence, as means of reliably forming interlayer communication of a multilayer printed circuit board, conventionally employed has been only a method for forming a through hole penetrating a substrate, however, in order to increase the optional degree of the design of a multilayer printed circuit board, recently it becomes general to form a via-hole with a smaller diameter, a blind via-hole (BVH) by drilling with a small diameter only to the surface of an inner layer copper foil without penetrating a substrate, an interstitial via-hole (IVH) and the like.

In the case of forming a hole with a small diameter such as the through hole, conventionally drilling process has been employed to form a hole with a small diameter in a printed circuit board. The drilling process makes processing of a plurality of printed circuit boards possible at once while the printed circuit boards being stacked and thus has an advantage as means of easily improving the productivity by making the drilling in multiple axes.

Conventionally, the formation of a hole with a small diameter by the drilling process is mainly to form a hole with 0.3 to 0.4 mm and owing to the recent technical advancement, hole formation with about 0.15 to 0.25 mm hole diameter has been made possible.

Further, using a cemented drill, drilling process with a hole diameter in a range of 0.05 to 0.1 mm has been examined, however there are still many objects left to be technically solved and also many problems regarding the drill life and existence of printed circuit boards hard to be drilled.

On the other hand, in practical commercial fields, the tendency of the preference for light weight, thin, short, and compact size of electronic and electric appliances has been proceeding at remarkable speed to make the situation no more capable to wait for the advancement of the drilling process technique. Therefore, laser processing technique has been employed to carry out processing of a hole with a diameter not bigger than 0.1 mm.

In the case of carrying out the small hole processing for a printed circuit board using the laser method, the processing can be supposed to be broadly categorized into two patterns; (1) the case that the initial radiation of laser is started from a substrate resin and (2) the case that the initial radiation of laser is started from the surface of a copper foil be formed into a circuit. At that time, the surface of a copper foil has luster and a property of reflecting the laser rays, so that the laser processing of the foregoing case (2) become more difficult.

Actually, laser processing in the conditions of the foregoing case (2) from the surface of a copper foil having luster is in almost impossible situation. That a copper foil reflects laser means the initial absorptivity of laser is inferior and it means that the drilling speed is retarded to result in decrease of the production efficiency. Therefore, in the case of laser hole formation in the foregoing pattern (2), a work of removing the outer layer copper foil has been required to be previously carried out at the hole formation point by etching. This method is a widely known method generally as a conformable mask method.

In this etching work, an etching resist is to be applied and the precision of the registration becomes a problem and it has extremely been difficult to keep the precision of the etching position for the hole formation as it is required. Hence, since the positioning of a land pod to be a connection point of an inner layer copper foil circuit and of a via-hole or the like formed by laser processing differs, a countermeasure performed is that the land pod of the inner layer copper foil circuit is designed to be a slightly large in expectation of the positioning error. That becomes a rather serious obstacle to make the inner layer copper foil circuit fine.

Moreover, it is natural that the hole formation processibility differs depending on the types of laser. That is, in the case of using YAG laser which has large energy absorptivity, processing of a copper foil layer does not become a trouble. On the other hand, it has been expected before to make carbon dioxide gas laser, which has a high output with a little power consumption, stably usable in terms of the processing cost. Consequently, it has been expected for long to develop a copper clad laminate of which a copper foil and a resin layer are possible to be simultaneously and stably processed by carbon dioxide gas laser without carrying out etching of a copper foil.

### BRIEF DESCRIPTION OF THE DRAWINGS

FIG. 1 and FIG. 4 are schematic cross-sectional views of the surface treated copper foils according to the invention.

FIG. 2 shows the results of simulation of copper foil temperature increase by laser.

FIG. 3 shows the correlation between a processed hole diameter and an additional metal layer.

FIG. 5 shows the correlation between the roughness of the roughened face of an electrodeposited copper foil and the laser beam reflectance.

FIG. 6 shows a photograph of the roughened face of a copper foil taken by a scanning electron microscope.

FIG. 7 shows a schematic cross-sectional view of a surface processing apparatus for manufacturing the surface treated copper foil according to the invention.

FIG. 8, FIG. 9, FIG. 10, FIG. 11, FIG. 13, FIG. 14, FIG. 15, and FIG. 16 show schematic cross-sectional views of an electrodeposited copper foil with carrier according to the invention.

FIG. 12 and FIG. 17 show schematic cross-sectional views of a surface processing apparatus to manufacture an electrodeposited copper foil with carrier according to the invention.

FIG. 18 shows a cross-sectional view of a hole part which cannot be formed well by carbon dioxide gas laser.

### SUMMARY OF THE INVENTION

Hence, according to the results of enthusiastic investigations, inventors of the invention invent a copper foil making a copper foil layer and a substrate resin layer capable to be simultaneously processed using carbon dioxide gas laser without removing the copper foil as in the conformable mask method mentioned above. Hereafter, the invention will be described.

The invention described in claim 1 is a surface treated copper foil for a printed circuit board derived from a copper foil with one side roughened, wherein the copper foil is a surface treated copper foil for processing for laser hole formation and provided with a nickel layer with a thickness of 0.08 to 2.0 μm as an additional metal layer in one side and subjected to the nodular treatment by fine copper particles in the other side.

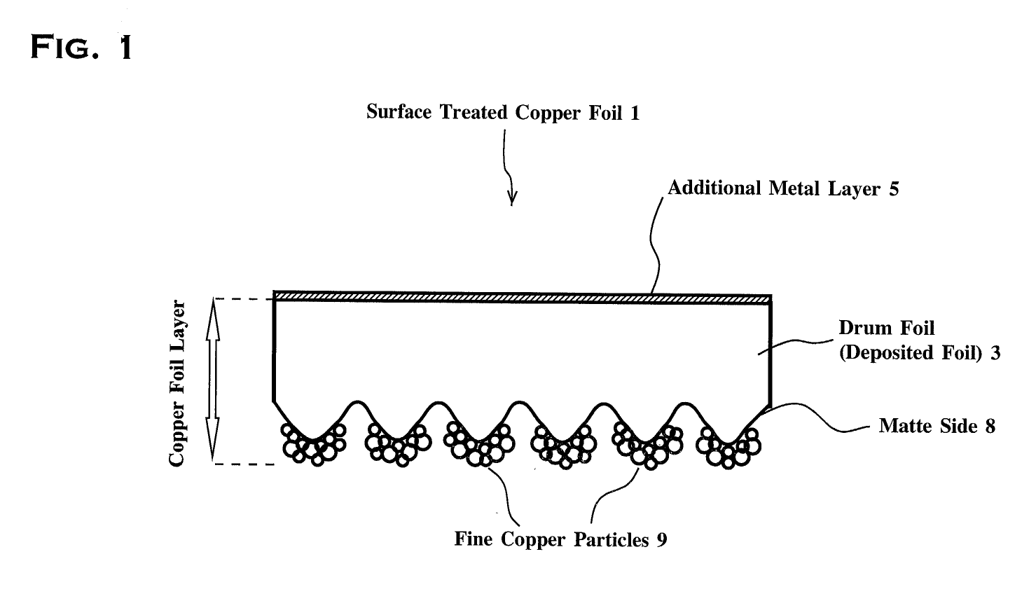

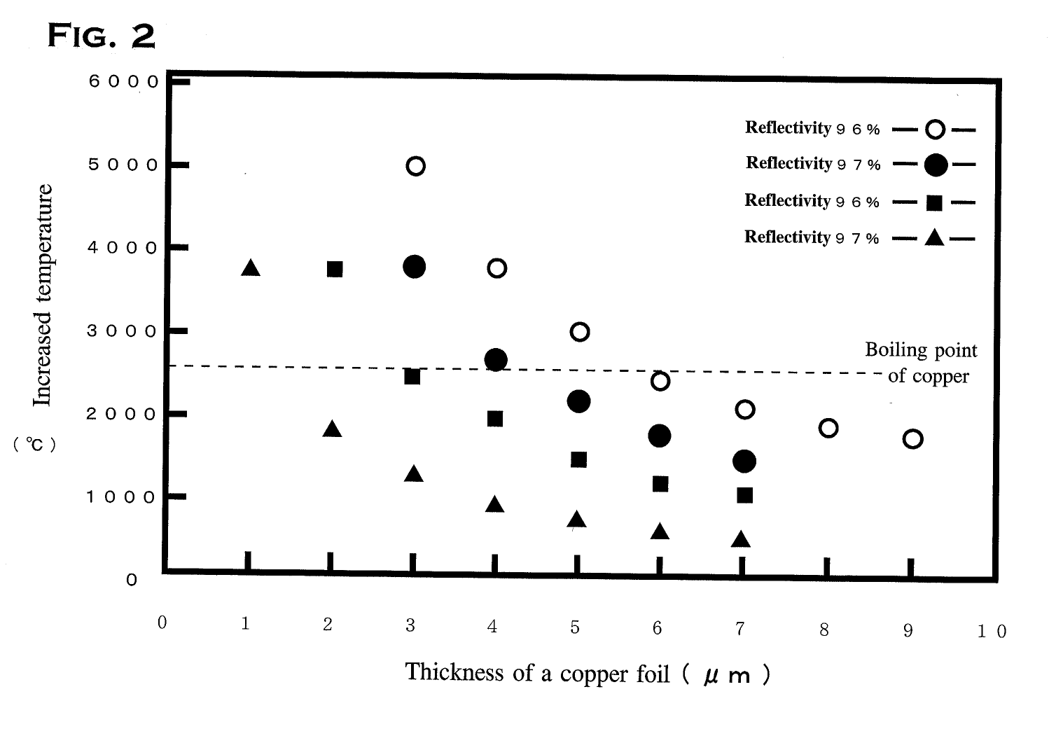

The surface treated copper foil is a surface treated copper foil subjected to an anti-corrosion treatment produced from an untreated electrodeposited copper foil before surface treatment (in this specification, an untreated copper foil obtained by electrolysis is sometimes referred as to a drum foil) obtained by an electrolysis process or a rolling method and provided with a nickel layer of 0.08 to 2.0 μm thickness in one side and bearing fine copper particles in the other side in order to obtain an anchor effect at the time of adhesion to a substrate (before and hereafter, the treatment is referred as to nodular treatment and the treated face is referred as to the roughened face). In the case of an untreated copper foil obtained by electrolysis, a nickel layer is to be formed in so-called shiny side and nodular treatment and anti-corrosion treatment are to be carried out in the roughened face side. FIG. 1 shows schematic cross-sectional view of a surface treated copper foil described in claim 1 and claim 2. Incidentally, the anti-corrosion treatment layer of the surface treated copper foil is eliminated in the figure. That is same as in the cases of showing the schematic cross-sectional views of other surface treated copper foils and electrodeposited copper foil with carriers.

As a surface treated copper foil having a similar layer constitution, described in the claim 2 is a surface treated copper foil for a printed circuit board produced from a copper foil subjected to an anti-corrosion treatment, wherein the surface treated copper foil is a surface treated copper foil for laser hole formation and provided with a cobalt layer of 0.05 to 3.0 μm thickness as an additional metal layer in the surface of one side and subjected to the nodular treatment by fine copper particles in the other side. The surface treated copper foil is a surface treated copper foil described as claim 1, in which the nickel layer is replaced with the cobalt layer. Consequently, in the description above and hereafter, the nickel layer and the cobalt layer are both referred as the additional metal layer.

To use a copper foil bearing an additional metal layer of nickel or cobalt in one face as described above as an outer layer copper foil of a printed circuit board makes it possible to carry out the processing for laser hole formation simultaneously in a copper foil and a substrate component without previously removing the copper foil by etching as in a conventional conformable mask method.

In the present stage, clear logic has not yet been established to explain why the processibility of laser hole formation is made easy by the existence of a nickel layer or a cobalt layer on a copper foil layer. However, according to the continuously carried out investigations, inventors of the invention become sure that the improvement of the processibility of laser hole formation is reliably attributed to the following principle.

Inventors of the invention assume the reasons of the difficulty of the hole formation processing of a copper foil simply by laser. There has been no theoretical research of laser processibility regarding a copper foil. Here, if laser output energy is defined as P and the surface reflectance and the thermal conduction loss is defined as η, the energy contributing to the temperature increase of an object to be processed becomes P (1−η). Consequently, P (1−η)=m·C·ΔT, wherein the reference character m can be defined as P (1−η)=π(d/e)²·H·ρ·C·ΔT wherein the diameter of a hole processed by laser is defined as d; the processing thickness as H; and the specific gravity of copper as ρ. Consequently, ΔT=4P(1−η)/(π·d²·H·ρ·C). Using the equation, the conditions of melting of copper are deduced. Here, while the pulse width being set to be 60 μsec., pulse energy 16.0 mJ, and laser beam diameter 160 μm, holes of 125 μm processed diameter are to be formed in copper foils with a variety of thicknesses and thus ρ=8.94 g/cm³, C=0.39 J/K·g, ΔT=4P(1−η)/(10.95·d²·H) is employed as a theoretical equation.

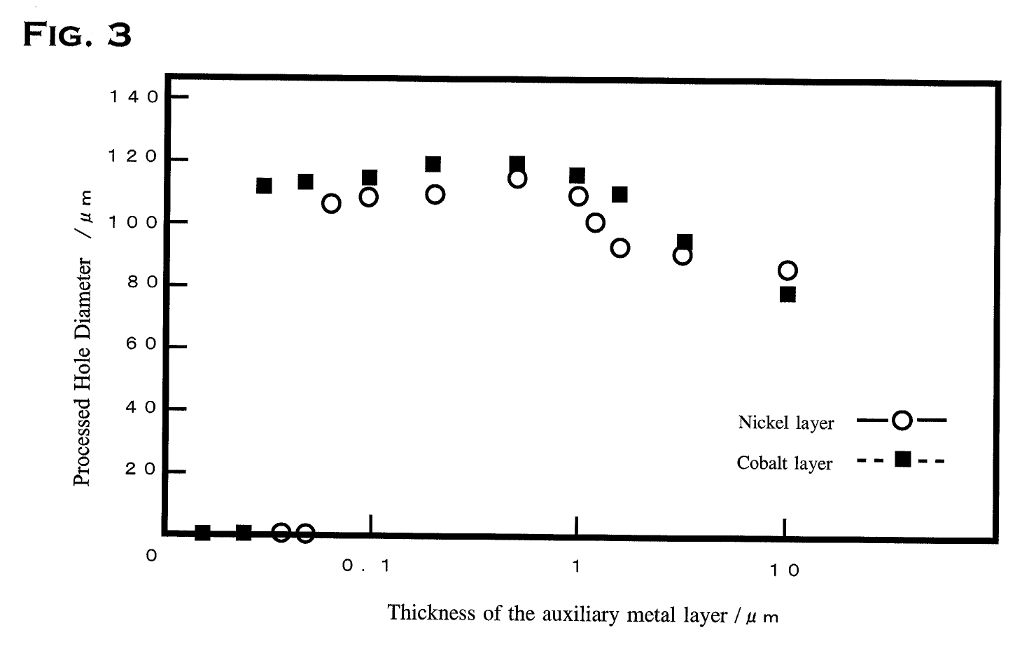

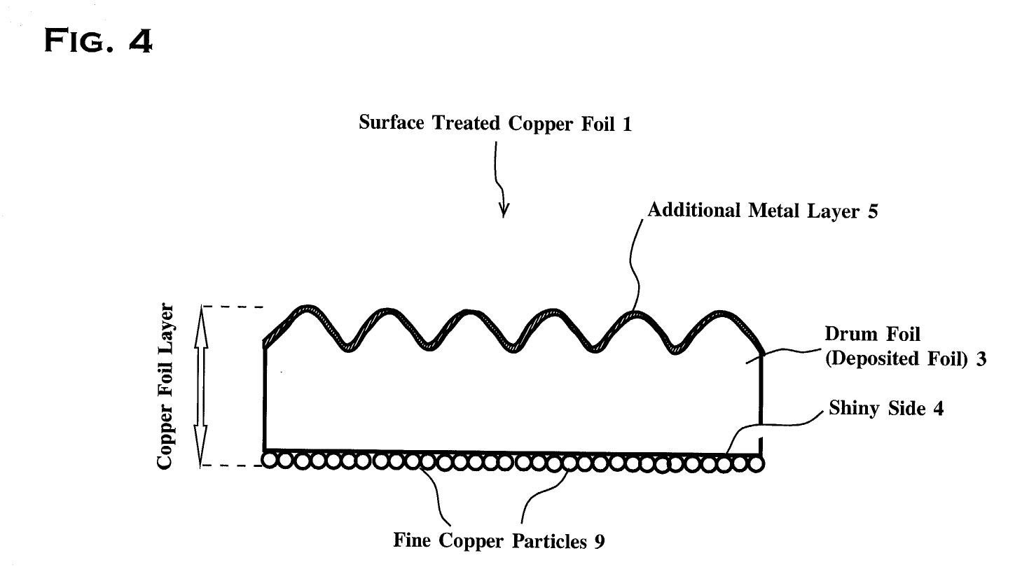

In order to make hole formation in a copper foil by laser possible, the laser has to be sufficient to melt copper and increase the temperature above the boiling point. Based on the theoretical equation, FIG. 2 shows the results of simulation of the increased temperature for respective the thicknesses of copper foils using the reflectance in the copper foil surface is employed as the value of η. As being understood from FIG. 2, the change of only 1% in reflectance causes a difference in the increased temperature of 1000° C. or more. Then, it can be understood that the reflectance has to be not higher than 98% to make hole formation possible in an extremely thin copper foil with a thickness of 3 to 4 μm.

The simulations described above are based on the assumption that the copper foil surface to be radiated with laser constantly keeps the assumed reflectance from the starting to the finishing of the process. By changing the roughness of the initial surface of a copper foil, it is made possible to keep the reflectance of the initial radiation face as it is aimed and generally, the surface of an outer layer copper foil of a copper clad laminate has the intrinsic roughness which the matte side of a copper foil has or a prescribed roughness and the surface, thus, cannot be said a smooth specular face. However, when the radiation of laser is started, the copper foil surface having a prescribed roughness starts melting and when the copper component of the initially radiated face melts and is evaporated, a smooth and specular copper surface is to be formed beneath. The reflectance of the copper foil surface becoming the specular surface is a surface generally having the reflectance of 98% of higher. As a result, laser processing becomes difficult for a copper foil layer in a prescribed depth.

To carry out hole formation processing of copper by laser processing, the copper has to be continuously be evaporated in a prescribed thickness of a copper foil. That is during the laser radiation, at least the radiated part has to be at a temperature exceeding the boiling point of copper.

If a nickel layer or a cobalt layer of a prescribed thickness is formed on the copper foil surface, the resulting foil is capable to easily keep the temperature at the part processed by laser at the boiling point of copper or higher. The nickel layer and the cobalt layer can be supposed to function as follows. Copper is an element classified in a noble metal of group IB of a periodic table and has physical properties; the melting point of 1,083° C., the boiling point of 2,582° C. and the thawing enthalpy (thawing heat) of 13.3 kJ/mol under the condition of 1.01×10⁵ Pa.

On the other hand, nickel is an element classified in group VIII elements of a periodic table and has physical properties; the melting point of 1,455° C., the boiling point of 2,731° C. and the thawing enthalpy (thawing heat) of 17.6 kJ/mol under the condition of 1.01×10⁵ Pa. And cobalt is also an element classified in group VIII elements of a periodic table and has physical properties; the melting point of 1,492° C., the boiling point of 2,747° C. and the thawing enthalpy (thawing heat) of 14.4 kJ/mol under the condition of 1.01×10⁵ Pa. The physical properties of nickel and cobalt are extremely similar and boiling points of both are at a temperature higher than that of copper by 150 to 160° C. in comparison with the boiling point of copper. So far the judgment deduced from the indication of the these physical properties, nickel and cobalt are supposed more stable than copper in relation to heat. Consequently, since the processing using laser is carried out by sharply raising the temperature of a part by supplying high energy to the part where laser is radiated and melting and evaporating the material of the part, it is supposed to be incapable to establish a theory that nickel and cobalt are easy to be bored as compared with copper.

However, here, the thermal conductivity of copper, nickel and cobalt are compared. The thermal conductivity of copper is 354 W·m⁻¹·K⁻¹ at 700° C. showing a high thermal conduction, whereas it is 71 W·m⁻¹·K⁻¹ at 700° C. for nickel and 69 W·m⁻¹·K⁻¹ at 700° C. for cobalt and the thermal conductivities of nickel and cobalt are about ⅕ of that of copper to make it clear that the heat conduction in nickel and cobalt is extremely slow as compared with that in copper. Taking that into consideration, when laser is radiated to the surface of copper foil of a copper clad laminate having no nickel layer or cobalt layer, some of the laser is reflected from the starting of the radiation from the specular surface of the copper foil and the remaining laser is applied to a prescribed position where a through hole or a hole part such as IVH or BVH are to be formed as thermal energy. At that time, as the surface of the copper foil is more specular, the reflectance of the laser is higher and the ratio of the laser to be converted into the thermal energy is lower. From the viewpoint of the surface of the entire copper clad laminate, the surface area of the part where the laser processing is carried out is extremely narrow and even if the part is instantaneously heated to a high temperature, the copper, which is a high thermal conductive material, immediately diffuses the heat quantity supplied by the laser and it is supposed to be difficult for the converged heat to remain there locally. That is, the specular face of the copper foil surface after the removal of the initially radiated surface has an increased reflectance of laser and the thermal energy supplied to the copper foil part where the laser is radiated is decreased and for that, it can be supposed that the heat supplied to the copper foil layer and the heat dispersed by diffusion become equilibrium at the temperature not higher than the boiling point of the copper to make the copper foil temperature at the radiated part difficult to be heated to the boiling temperature or higher.

On the contrary, nickel or cobalt transmits heat only at a speed of about ⅕ of the thermal conductivity of copper. Consequently, if laser is radiated to the surface of the nickel layer or the cobalt layer formed on a copper foil of a copper clad laminate, the thermal energy of the laser is converged only on the radiated part of the additional metal layer and as compared with the thermal diffusion speed, the supply speed of the thermal energy by the laser is high and thus it is supposed that the part where the laser is radiated easily reaches the melting point of nickel or cobalt. Moreover, in comparison of the laser reflectance of copper and nickel with the same surface roughness, the reflectance of nickel and cobalt is clearly smaller by at least 1 to 2% and the absorptivity of laser is increased. That implies, as it is made clear from the above-described temperature increase simulation of a copper foil, the probability the temperature of the radiated part is increased to 1,000° C. or higher. From the viewpoint of the actual case, the temperature increase is supposed to be equivalent to at least around several hundred ° C.

As a result, as compared with a copper foil and although their melting points are higher than that of copper, nickel or cobalt is quickly heated by laser radiation and is supposedly easily melted and evaporated. Then, when nickel or cobalt having a higher melting point than that of copper once starts melting and reaches the boiling temperature, the heat which increases the temperature of nickel or cobalt to the boiling point is transmitted to a copper foil made of copper having a high thermal conductivity and the continuous laser radiation and the thermal energy supply in combination supposedly cause temperature increase easily exceeding the melting temperature of copper and become the driving force to increase the copper foil temperature at the laser radiated part to the boiling point of copper to easily remove the copper foil layer by laser and also easily remove the copper foil layer of a copper clad laminate and a substrate resin layer simultaneously. An additional metal layer of nickel or cobalt in a surface treated copper foil and an electrodeposited copper foil with carrier to be described hereafter takes the similar role to that as described above.

An additional metal layer to be formed on the surface of a surface treated copper foil is preferably 0.08 to 2 μm for a case of a nickel layer and 0.05 to 3 μm for a case of a cobalt layer. They are determined as ranges in which processing can easily be carried out by pulsed energy of 12 to 30 mJ employed generally in the case of carbon dioxide gas laser. The drillability by carbon dioxide gas laser in a copper clad laminate produced using the surface treated copper foil bearing the additional metal layer as an outer layer copper foil is 100% and the copper foil and the substrate component are reliably simultaneously bored. Therefore, to regulate the thickness of the additional metal layer, inventors of the invention pay an attention to the relation of the thickness of an additional metal layer of a surface treated copper foil and the actually measured value of a processed hole diameter.

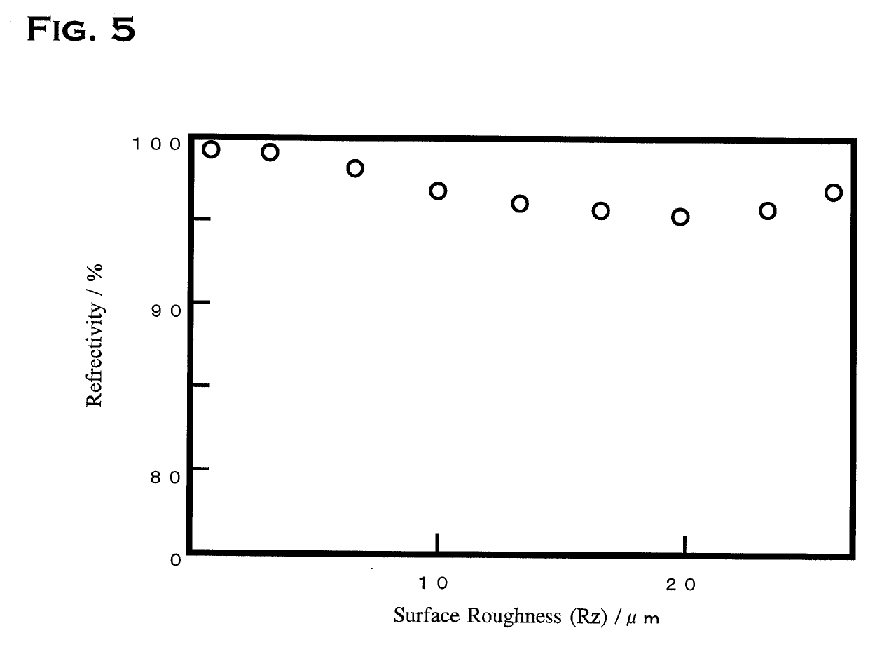

FIG. 3 shows the relation between the thickness of an additional metal layer of a surface treated copper foil and the actually measured value of a processed hole diameter. The carbon dioxide gas laser radiation conditions at that time are controlled to be 2,000 Hz frequency, 5.0 mm mask diameter, 60 μsec. pulse width, 16.0 mJ pulsed energy, 0.8 off set, and 140 laser diameter and the laser radiation is carried out so as to form holes of 110 μm processed hole diameter in copper clad laminates with a variety of copper foil thicknesses. Consequently, as the determination standards, inventors of the invention determine that the processing is well performed if the hole diameter after the processing is in a range of 100 to 110 μm.

As being made clear from FIG. 3, the hole diameter after processing sharply becomes excellent with the thickness of 0.8 μm as a critical value in the case of nickel and with the thickness of 0.05 μm as a critical value in the case of cobalt. And as the thickness of an additional metal layer of nickel or cobalt becomes thicker, the hole diameter after processing contrary becomes smaller. That is supposedly owing to that if the distance to a copper foil is long after the laser penetrates an additional metal layer, the hole formed in the additional metal layer is deep and focusing of the laser takes place to converge the laser which practically comes into collision against the copper foil layer.

Further, if an additional metal layer is too thick, the surface of nickel or cobalt composing the additional metal layer and once melted becomes smooth to increase the reflectance of the laser, so that it can be supposed that the temperature increase of the additional metal layer as same as that in the initial period of starting the laser radiation cannot be expected and as a result, the processing speed is slow down and the hole diameter precision is deteriorated. Consequently, as the range in which the practically measured value of the processed hole diameter can reliably be about 100 μm and which is clearly judged from FIG. 3, the upper limit is 2 μm thickness in the case of nickel and the upper limit is 3 μm thickness in the case of cobalt. Further, according to the results obtained by increasing the number N of the laser hole processing times and statistic judgment by increasing, it can be determined that the thickness in a range of 0.2 to 0.8 μm and the thickness in a range of 0.1 to 0.9 μm are more preferable in the case of nickel and in the case of cobalt, respectively, in order to stably form holes with the hole diameter after processing approximately to be the aimed hole diameter.

The formation of the nickel layer or the cobalt layer is preferably carried out by any one of methods, for example, a dry method such as a vapor deposition or a sputtering and a plating method employing an electrochemical technique. Because these techniques are easy to control the layer thickness. The vapor deposition is a method for evaporating nickel or cobalt put in a heating basket by heating at a high temperature in a vacuum chamber with the pressure as low as 0.13 Pa to deposit on the surface of a copper foil: the sputtering is a method for forming an additional metal layer on the surface of a copper foil using a target material of nickel or cobalt by hitting ion of argon or the like to the target to pull out nickel or cobalt atoms and depositing the atoms on the surface of the copper foil. These formation conditions may properly be selected corresponding to the respective processes in consideration of the productivity.

In the case of forming a nickel layer, the electrochemical technique to be employed can be carried out while using a solution applicable for a nickel plating solution in a wide range of option. For example, applicable are (1) conditions of using nickel sulfate in 5 to 30 g/l nickel concentration, the solution temperature of 20 to 50° C., pH of 2 to 4, and the current density of 0.3 to 10 A/dm²; (2) conditions of using nickel sulfate in 5 to 30 g/l nickel concentration, potassium pyrophosphate of 50 to 500 g/l, the solution temperature of 20 to 50° C., pH of 8 to 11, and the current density of 0.3 to 10 A/dm²; (3) conditions of using nickel sulfate in 10 to 70 g/l nickel concentration, boric acid of 20 to 60 g/l, the solution temperature of 20 to 50° C., pH of 2 to 4, and the current density of 1 to 50 A/dm²; and other than those, the general Watts bath conditions. Further, it is also possible to employ an electroless nickel plating method as the electrochemical technique.

In the case of forming a cobalt layer, it is possible to use a solution to be employed as a cobalt plating solution. For example, applicable are (1) conditions of using cobalt sulfate in 5 to 30 g/l cobalt concentration, trisodium citrate of 50 to 500 g/l, the solution temperature of 20 to 50° C., pH of 2 to 4, and the current density of 0.3 to 10 A/dm²; (2) conditions of using cobalt sulfate in 5 to 30 g/l cobalt concentration, potassium pyrophosphate of 50 to 500 g/l, the solution temperature of 20 to 50° C., pH of 8 to 11, and the current density of 0.3 to 10 A/dm²; (3) conditions of using cobalt sulfate in 10 to 70 g/l cobalt concentration, boric acid of 20 to 60 g/l, the solution temperature of 20 to 50° C., pH of 2 to 4, and the current density of 1 to 50 A/dm²; and the like.

A surface treated copper foil as described in claim 3 and claim 4 is similar to that described in claim 1 and claim 2 in terms of the layer constitution. Claim 3 describes a surface treated copper foil for processing for laser hole formation, wherein the surface treated copper foil is a surface treated copper foil for a printed circuit board obtained by subjecting one face of an electrodeposited copper foil produced by electrolysis in a copper electrolytic solution to nodular treatment and provided with a nickel layer with a thickness of 0.05 to 2.0 μm in a surface of the roughened face of the electrodeposited copper foil and the matte side of the electrodeposited copper foil subjected to the nodular treatment by fine copper particles. And, claim 4 describes a surface treated copper foil for processing for laser hole formation, wherein the surface treated copper foil is a surface treated copper foil for a printed circuit board obtained by subjecting one face of an electrodeposited copper foil produced by electrolysis in a copper electrolytic solution to nodular treatment and provided with a cobalt layer with a thickness of 0.03 to 3.0 μm in a surface of the roughened face of the electrodeposited copper foil and the matte side of the electrodeposited copper foil subjected to the nodular treatment by fine copper particles.

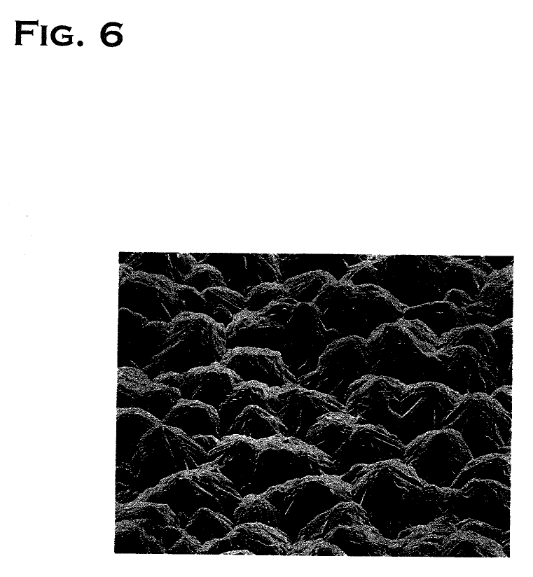

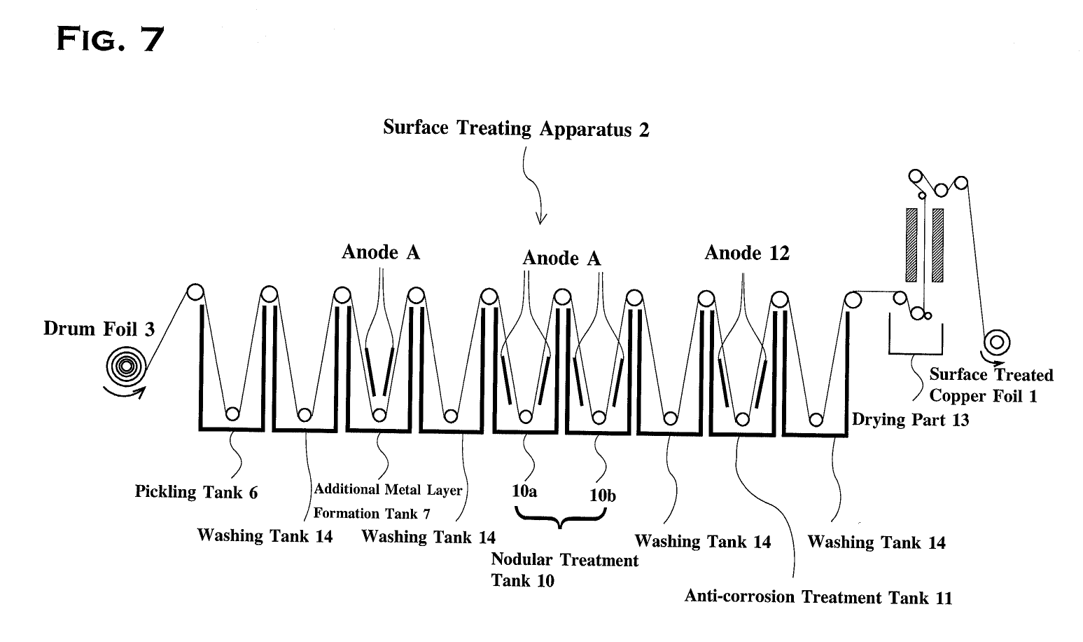

FIG. 4 shows the schematic cross-sectional view of these surface treated copper foils. As being understood from FIG. 4, the additional metal layer in these cases is formed in the roughened face side and the side to be employed as an adhesive face to a substrate is in the shiny side to which the fine copper particles are deposited and these are different points from the cases of the surface treated copper foils described in claim 1 and claim 2. Supposing the case using such a surface treated copper foil as an outer layer copper foil of a copper clad laminate, an additional metal layer having a convexoconcave shape similar to the roughened face of the electrodeposited copper foil is positioned in the surface layer on the contrary to that the smooth additional metal layer is positioned in the surface layer in the case of using the surface treated copper foils as described in claim 1 and claim 2.

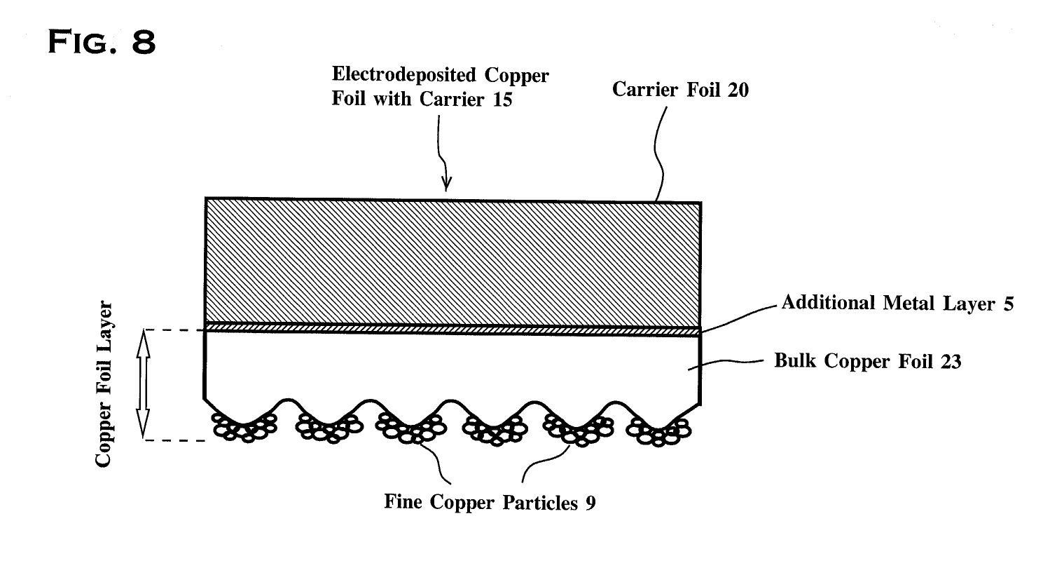

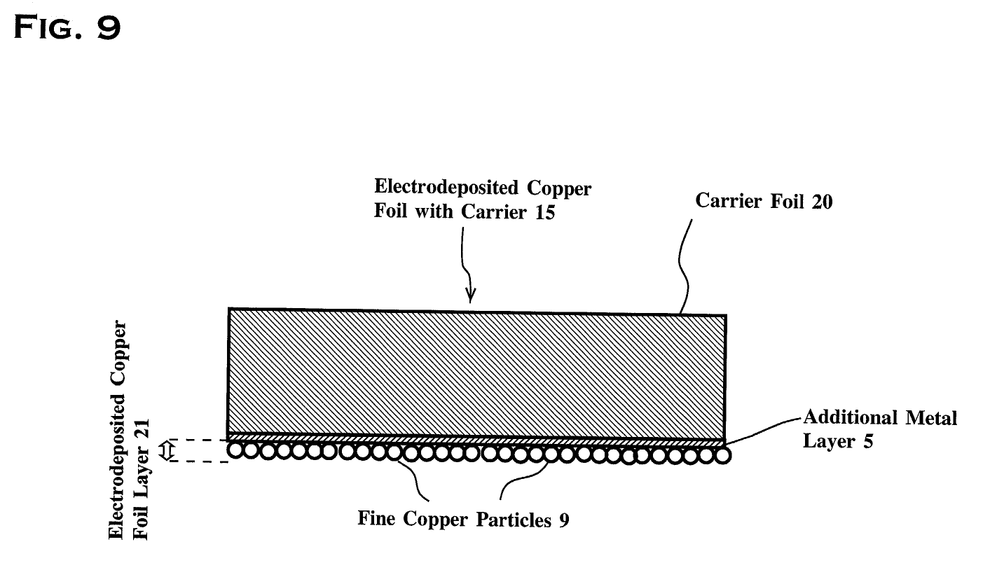

The role which the additional metal layer; a nickel layer or a cobalt layer, takes at the time of processing by laser are same in these surface treated copper foils as described in the description for claim 1 and claim 2 and the reasons for the restriction of the thickness of the nickel layer and the cobalt layer are also same. Here, duplicated description will be omitted. Other characteristics of the inventions described in claim 3 and claim 4 are that the additional metal layer has a convexoconcave shape. Consequently, owing to the effect of the formation of the additional metal layer and owing to the formation of the convexoconcave shape, the processibility of laser hole formation is improved. Hereafter, the effect of the convexoconcave shape will be manifested in relation to the reflectance of laser. FIG. 5 shows the relation between the surface roughness and the laser reflectance utilizing the difference of the roughness of the roughened face of an untreated copper foil.

Being made clear from FIG. 5, it is understood that the laser reflectance becomes lower as the surface is roughened more until the roughness of the copper foil surface reaches a prescribed roughness (Rz). That is, as compared with a case of a smooth surface, the surface having a rather convexoconcave shape increases the absorptivity of laser to prove that the temperature increase of the radiated part is easy to take place. That is, the surface having the convexoconcave shape supposedly properly causes laser diffused reflection of the laser to improve the utilization efficiency of the laser.

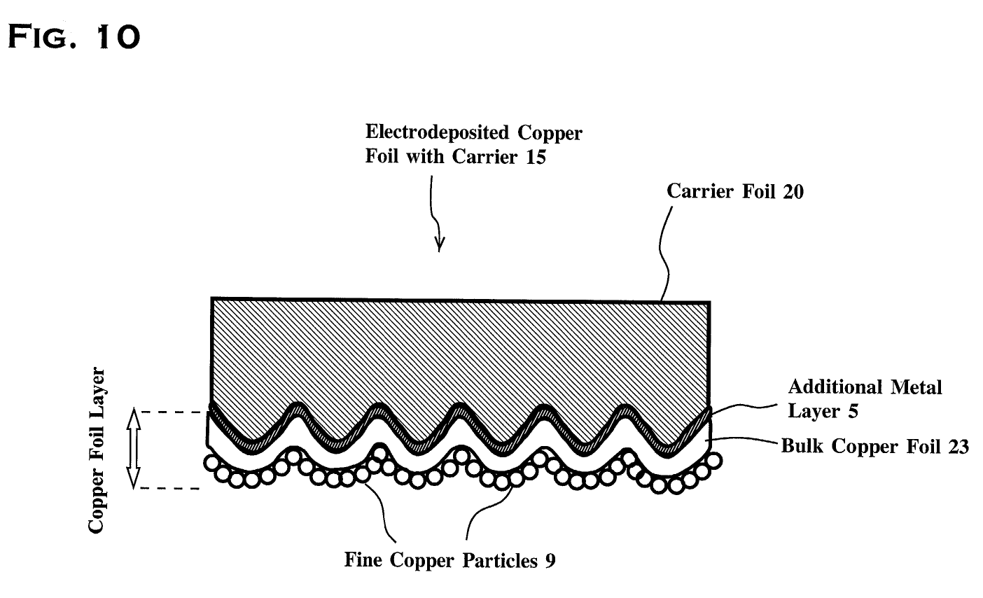

However, in the region of Rz exceeding 20.0, the reflectance rather tends to be increased. That is corresponding to the roughness of the matte side of 70 μm or thicker in the thickness of an electrodeposited copper foil. That is, as shown in FIG. 6, the shape of the matte side of an electrodeposited copper foil has a hill-like convexoconcave shape and as the thickness of a copper foil is thicker, the duration of electrolysis at the time of manufacture is prolonged and the size of each of the hill-like shape of the matte side becomes large and by the roughness measurement, the copper foil is measured simply as a foil with high profile. However, in order to keep the reflectance of laser to the minimum line, as it is said that those having the similar roughness to the wavelength of the laser are most excellent and even in the case where the roughened face shape of a copper foil is tried to be positively utilized just like the invention, it is supposed that there is a proper range of the convexoconcave shape. Consequently, in the invention, it is determined that using an electrodeposited copper foil with the nominal thickness of 70 μm or thinner is preferable for those which utilize the matte side of an electrodeposited copper foil. That is an important factor even in the case of using an electrodeposited copper foil for a carrier foil of an electrodeposited copper foil with carrier, which will be described below.

The roughness formed in the matte side of an electrodeposited copper foil is as shown in FIG. 6 is a hill-like convexoconcave shape and an additional metal layer is to be formed on the surface of the hill-like shape. Consequently, when laser radiation is started to the additional metal layer surface having the hill-like shape, the temperature increase is supposed to be fastest in the tip parts (the summit parts of the hill-like shape) of the hill-like convexoconcave shape. Generally, it is said that when those having projected parts and flat parts are put in a constant and high temperature atmosphere, as compared with the temperature increase in the flat parts, the speed of the temperature increase in the projected parts reaches about 6 times fast and the same phenomenon supposedly takes place. As a result, starting the radiation of laser causes sharp temperature increase in the tip parts of the hill-like convexoconcave shape of the matte side bearing the additional metal layer and as compared with the case of radiating laser to a smooth face, the additional metal layer easily reaches the boiling point to be melted and evaporated. After that, as described in the description regarding claim 1 and claim 2, evaporation of the additional metal layer and the copper foil layer is supposed to continuously take place to make simultaneous removal of the copper foil and the substrate resin layer possible.

The surface treated copper foils as above-described in claim 1 to claim 4 are to be employed for printed circuit board manufacture by carrying out laser hole processing after copper clad laminates are manufactured using these surface treated copper foils as outer layer copper foils; removing the additional metal layers by an etching method, and then conventional etching processes. Consequently, unlike a conformal mask layer, since no previous copper foil removal of the parts where laser radiation is carried out is required, it is possible to make the positioning precision of a circuit excellently high, shorten the process and effectively lower the manufacturing cost of a printed circuit board.

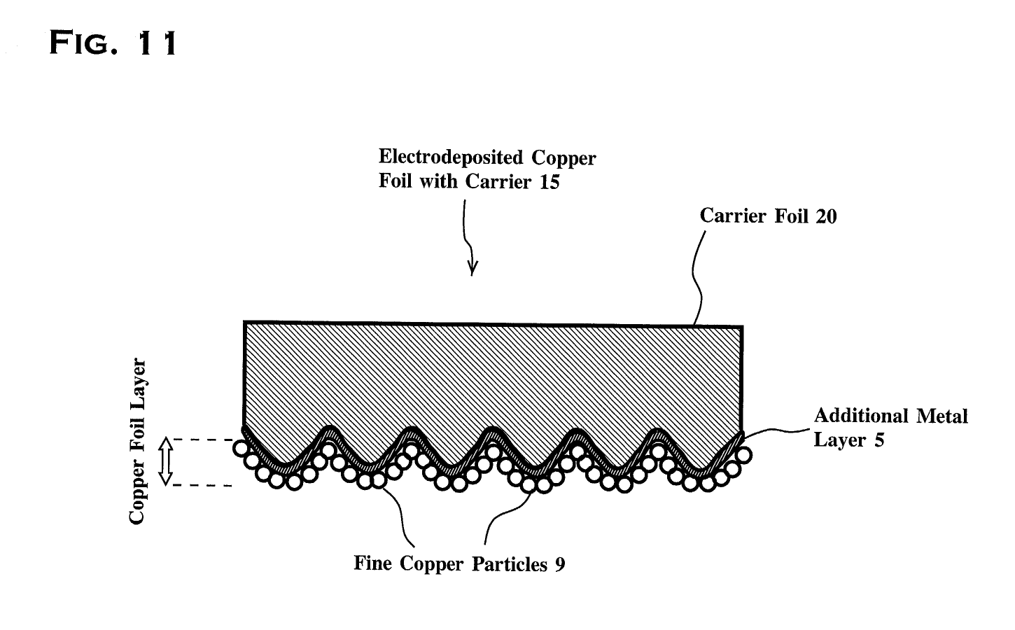

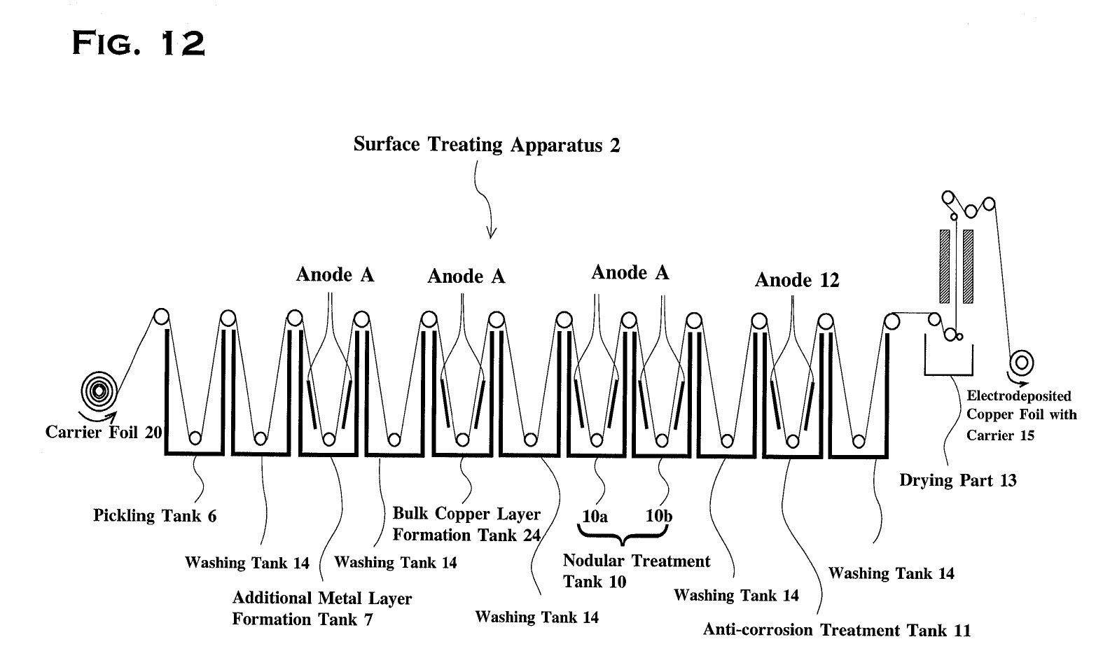

The surface treated copper foils of claim 1 to claim 4 can be manufactured by employing a so-called surface treatment apparatus to generally carry out surface treatment of a copper foil. According to FIG. 7, the manufacturing method will be described.

In the surface treatment apparatus, an untreated copper foil rolled like a roll is unrolled in one direction and the untreated copper foil is passed respectively through a properly arranged water-rinsing treatment tank, a continuously arranged pickling tank, an additional metal layer formation tank, a surface nodular treatment tank for forming fine copper particles, an anti-corrosion treatment tank, and a drying part

At that time, by changing the unwinding direction of the untreated copper foil rolled like a roll, a desired additional metal layer is made possible to be formed in either the matte side or the roughened face of the copper foil. The pickling tank to which the unrolled copper foil is to be passed through at first is for so-called pickling process to be carried out for the purpose to carry out degreasing treatment for completely removing the oil and fat components adhering to the untreated copper foil and surface oxide coating removal. By passing the untreated copper foil through the pickling tank, the untreated copper foil is cleaned to reliably carry out even electrode position in the following processes. For the pickling, a variety of solutions such as a hydrochloric acid type solution, a sulfuric acid type solution, a sulfuric acid-hydrogen peroxide type solution, and the like are usable and not needed to be particularly restricted. Regarding the solution concentration and the solution temperature, they are properly adjusted corresponding to the characteristics of the production line.

On completion of the pickling, the untreated copper foil is washed with water and then to be led to an additional metal layer formation tank. The additional metal layer formation tank is filled with either one solution, a nickel plating solution or a cobalt plating solution as described above, an additional metal layer with a prescribed thickness is to be formed while the untreated copper foil being passed through the additional metal layer formation tank. At that time, an anode is installed parallel to one side of the untreated copper foil led to the plating solution at a distance and the untreated copper foil is cathode-polarized to smoothly plate the additional metal layer on the copper foil surface. Hereafter, for the tank employing the electrode position, those equipped with a similarly installed anode are employed.

Then, on completion of the additional metal layer formation, as a process of forming fine copper particles on the copper foil surface on the opposite to the side where the additional metal layer is formed, the untreated copper foil is led to the surface nodular treatment tank. The treatment to be carried out in the surface nodular treatment tank is further divided into a process of depositing and sticking fine copper particles to the untreated copper foil and a process of seal plating for preventing the dropping of the fine copper particles.

For the process of the depositing and sticking fine copper particles to the surface of the untreated copper foil, a so-called copper plating solution is employed as a copper ion supply source. However, a general level plating condition is not employed but electrode position condition employed is burn plating condition in this case. Consequently, as compared with a general copper plating solution, the solution concentration is controlled to be low so as to easily produce the burn plating condition. The burn plating condition is not particularly restricted but can be determined taking the characteristics of the production line into consideration. For example, in the case of using a copper sulfate type solution, the copper concentration is 5 to 20 g/l, sulfuric acid is 50 to 200 g/l, additives (α-naphthoquinolin, dextrin, glue, thiourea, and the like) are added based on necessity, the solution temperature is 15 to 40° C., the current density is 10 to 50 A/dm².

The seal plating process for preventing the dropping of the fine copper particles is a process for evenly depositing copper level so as to cover the fine copper particles in level plating condition in order to prevent the dropping of deposited and stuck fine copper particles. Consequently, also in this case, a copper plating solution may be employed as a copper ion source. The level plating condition is not particularly restricted but can be determined taking the characteristics of the production line into consideration. For example, in the case of using a copper sulfate type solution, the copper concentration is 50 to 80 g/l, sulfuric acid is 50 to 150 g/l, the solution temperature is 40 to 50° C., the current density is 10 to 50 A/dm², and the like.

The anti-corrosion treatment tank is for a process for carrying out a treatment to prevent oxidation corrosion of the surface of an electrolytic copper layer so as to avoid a trouble in the manufacturing process of a copper clad laminate and a printed circuit board. The method employed for the anti-corrosion treatment may be carried out using either an organic anti-corrosion agent such as benzotriazole, imidazole and the like or an inorganic anti-corrosion agent such as zinc, chromate, a zinc alloy and the like without any inconvenience. A proper anti-corrosion agent corresponding to the use of the copper foil may be selected. In the case of using an organic anti-corrosion agent, usable techniques are immersion coating with an organic anti-corrosion agent, showering, electrodeposition and the like. In the case of using an inorganic anti-corrosion agent, a method for plating an anti-corrosion element on the surface of an electrodeposited copper foil layer by electrodeposition and as another method, so-called replacement deposition method and the like. For example, if a zinc anti-corrosion treatment is carried out, usable are a zinc pyrophosphate plating bath, a zinc cyanide plating bath, a zinc sulfate plating bath and the like. For example, in the case of using the zinc pyrophosphate plating bath, the conditions are the zinc concentration of 5 to 30 g/l, potassium pyrophosphate of 50 to 500 g/l, the solution temperature of 20 to 50° C., pH of 9 to 12, the current density of 0.3 to 10 A/dm².

The drying part is for a process to be carried out as a final process to wind a surface treated copper foil derived from the untreated copper foil passed through the tanks filled respectively with the above-described various solutions for the respective processes and completed into a roll-like shape. That is, the completed surface treated copper foil still in wet state is passed through a heated drying furnace. Through these processes, the surface treated copper foils described in claim 1 to claim 4 are manufactured.

The thickness of the surface treated copper foils described in claims 1 to 4 is limited to be as thin as about the nominal thickness of 7 μm in consideration of the present manufacturing technical level of the surface treated copper foils. On the contrary, claims 5 to 16 describe an electrodeposited copper foil with carrier, an extremely thin copper foil with a nominal thickness thinner than 7 μm, capable to be manufactured by mass production. The extremely thin copper foil is to be employed for manufacturing a high density printed wiring board by being stuck to a polymer insulating substrate such as a glass-epoxy substrate, a phenol substrate, a polyimide and the like by hot press lamination to be a copper clad laminate.

The hot press lamination is carried out by stacking a copper foil, a prepreg (a substrate) cured to be in B stage, and other mirror plates to be spacers and applying high pressure to the resulting body in a high temperature atmosphere, and thermally bonding the copper foil and the prepreg (hereafter, the process may be referred as to hot pressing) to obtain a copper clad laminate. In this case, if there is a wrinkle in the copper foil, cracking takes place in the wrinkling part of the copper foil and it sometimes becomes a cause of bleeding of the resin out of the prepreg or disconnection of a formed circuit in the printed circuit board manufacturing process, which comprises an etching process to be carried out later.

The formation of the wrinkle in the copper foil becomes a more serious problem as the copper foil becomes thinner. The electrodeposited copper foil with carrier is known as a copper foil to solve such a problem and further to prevent foreign substance contamination in the matte side of the copper foil at the time of thermal molding press. That is, the electrodeposited copper foil with carrier is just like a laminate composed of a carrier foil and an electrodeposited copper foil laminated with each other and capable to be subjected to hot pressing while the carrier foil being laminated and immediately before a copper circuit formation, the carrier foil can be removed. Consequently, it is made possible to prevent occurrence of wrinkling at the time of handling and of pressing of an electrodeposited copper foil and to prevent surface contamination as a copper clad laminate.

In the present specification, although the name as a carrier foil is employed, the carrier foil is a foil to be employed in the state just as it is stuck in face-to-face to an electrodeposited copper foil. The carrier foil in the present specification has the following properties. Taking the manufacturing method of an electrodeposited copper foil with carrier according to the invention into consideration, since the copper component to be an electrodeposited copper foil is electrolytically deposited on the surface of a carrier foil, at least the surface of the carrier foil is required to have electric conductivity. Further, since the electrodeposited copper foil with carrier is passed through continues manufacturing processes and at earliest, until the completion of the manufacture of the copper clad laminate, it has to keep the joined state with the electrodeposited copper foil layer to make the handling easy and reinforce the electrodeposited copper foil in any means and it has a roll to protect the electrodeposited copper foil, the carrier foil is required to have a prescribed strength. If satisfying these requirements, any material can be used as a carrier foil and generally the material is supposed to be a metal foil, however it is not restricted to that.

The electrodeposited copper foil with carrier can broadly be divided to peelable types and etchable types. To say the difference by one word, the peelable types are carrier foils to be removed after hot pressing, whereas the etchable types are carrier foils to be removed by an etching method after hot pressing. Claim 5 to claim 10 describe the electrodeposited copper foil with carriers comprising the latter etchable types and claim 11 to claim 16 describe the electrodeposited copper foil with carrier comprising the former peelable types.

Here, at first, the electrodeposited copper foil with carrier comprising the etchable carrier described in claim 5 to claim 10 will be described. Claim 5 describes an electrodeposited copper foil with carrier having a three-layer structure composed of a carrier foil layer, an additional metal layer, and an electrodeposited copper foil layer, wherein the carrier foil is of a metal material having a smooth surface with the roughness (Rz) of 0.05 to less than 4.0 μm, the additional metal layer is a nickel layer with the thickness of 0.08 to 2.0 μm thickness in the smooth surface side of the carrier foil, and the electrodeposited copper foil layer is composed of a bulk layer and fine copper particles in the surface of the additional metal layer to be an electrodeposited copper foil with carrier for processing for laser hole formation.

Further, claim 6 describes an electrodeposited copper foil with carrier having a three-layer structure composed of a carrier foil layer, an additional metal layer, and an electrodeposited copper foil layer, wherein the carrier foil is of a metal material having a smooth surface with the roughness (Rz) of 0.05 to less than 4.0 μm, the additional metal layer is a cobalt layer with the thickness of 0.05 to 3.0 μm thickness in the smooth side of the carrier foil, and the electrodeposited copper foil layer is composed of a bulk layer and fine copper particles on the surface of the additional metal layer to be an electrodeposited copper foil with carrier for processing for laser hole formation.

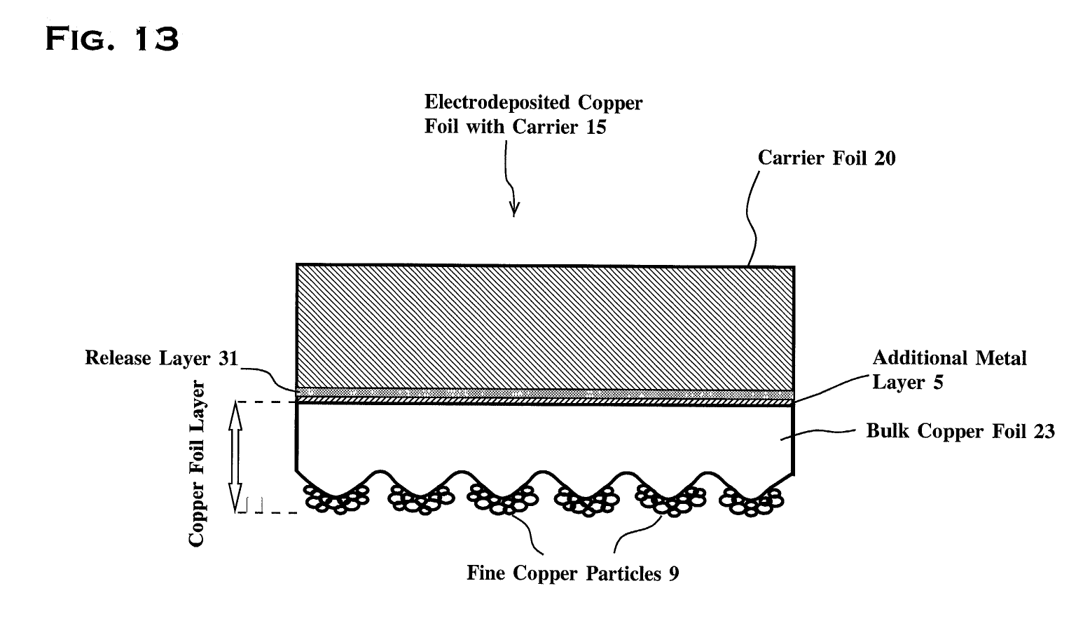

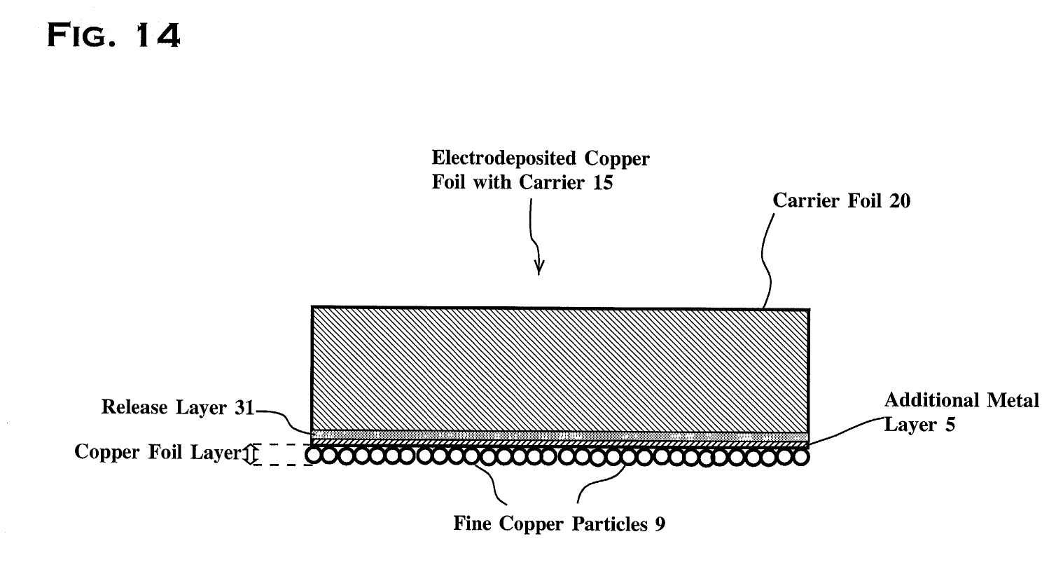

The copper foils described in claim 5 and claim 6 are electrodeposited copper foil with carrier each comprising the additional metal layer with the prescribed thickness positioned in the surface of the carrier foil made of a metal having the smooth surface with 0.05 to less than 4.0 μm roughness (Rz) and the electrodeposited copper foil positioned in the surface of the cobalt layer and FIG. 8 shows the schematic cross-sectional structure. The copper foils are to be employed for laser processing after being processed to be copper clad laminates and then etched to remove the carrier foils and the shape of the surface of the additional metal layers is affected by the shape of the surface of the carrier foils. Consequently, the balance of the roughness of the surface of carrier foils and the thickness of the additional metal layers becomes an important factor.

If the roughness (Rz) of the surface of a carrier foil to be employed here is smaller than 0.05 μm, although it depends on the type of a metal material to be employed for the carrier foil, the bond strength of the necessary minimum limit cannot be maintained between the carrier foil and an additional metal layer to be formed thereon to result in a so much easily separable one.

The copper foils described in claim 5 and claim 6 after removal of the carrier foils become similar copper foils to those described in claim land claim 2. Consequently, because of the same reasons as described above, the additional metal layers to be formed on the carrier foils of metals each having a smooth surface with the roughness (Rz) of 0.05 to less than 4.0 μm, are required to have the thickness controlled to be 0.08 to 2.0 μm in the case of the nickel layer and to be 0.05 to 3.0 μm in the case of the cobalt layer. Also, the role which the additional metal layers; the nickel layer and the cobalt layer; have to perform at the time of processing by laser beam is same as described in the description of claim 1 and claim 2 and the reason for the restriction of the thickness of the nickel layer and the cobalt layer is also same, so that duplicated explanation is omitted here.

Claim 7 describes an electrodeposited copper-foil with carrier having a three-layer structure composed of a carrier foil layer, an additional metal layer, and an electrodeposited copper foil layer, wherein the carrier foil is of a metal material having a smooth surface with the roughness (Rz) of 0.05 to less than 4.0 μm, the additional metal layer is a nickel layer or a cobalt layer with the thickness of 0.03 to 1.0 μm thickness in the smooth surface side of the carrier foil, and the electrodeposited copper foil layer only comprises fine copper particles in the surface of the additional metal layer to be an electrodeposited copper foil with carrier for processing for laser hole formation. As being understood from the schematic cross-sectional view of FIG. 9, the electrodeposited copper foil layer comprises only fine copper particles and has no bulk copper to be a conductor of a circuit of a printed circuit board, so that practically it cannot be used as it is for the use for a printed circuit board.

However, if the electrodeposited copper foil with carrier described in claim 7 is used for an outer layer copper foil of a copper clad laminate, the following use manner is made possible and the laser processibility becomes extremely excellent. If a copper clad laminate is manufactured using the electrodeposited copper foil with carrier, at first, the carrier foil is to be removed by etching. On completion of the removal of the carrier foil, the additional metal layer of nickel or cobalt becomes a surface of the copper clad laminate. Consequently, the laser hole formation processing is to be carried out in this stage. At that time, if no bulk copper exists, the copper amount to be evaporated is about a half or less as compared with that in the case where the bulk copper exists and it becomes sufficient to evaporate only the copper in the fine copper particle state. Moreover, since the fine copper particles have approximately spherical shapes, even if they are deposited evenly, they keep a constant convexoconcave shape to lower the reflectance of laser and increase the laser processing efficiency. Therefore, heat quantity exceeding the above-described boiling point of nickel or cobalt affect to make laser processing easy to be carried out.

As a results, in either case of forming a nickel layer or a cobalt layer, if the thickness of the additional metal layer is at thinnest 0.03 μm, in terms of the size of the fine copper particles to be employed generally for the electrodeposited copper foil, laser hole formation processing can be excellent in practical operation. Even if fine copper particles with considerably large particle size about 2 times as large as that of conventional fine copper particles, if the thickness of the additional metal layer is 1.0 μm, excellent laser processing is made possible. Incidentally, similarly to the case where the additional metal layer is to be formed as described above in the smooth face, the upper limit may be set to be 2 μm in the case of nickel and to be 3 μm in the case of cobalt without any trouble.

On completion of the laser processing, the nickel layer or the cobalt layer is removed by etching to leave only the fine copper particles on the surface of the copper clad laminate. After that, at the time of plating treatment for reliably obtain electric connection of a via-hole and a through hole, copper is deposited in the inner wall of the via-hole, the through hole and at the same time the bulk copper layer is formed on the surface of the fine copper particles of the copper clad laminate. In such a manner, while the bulk copper layer being thin, a printed circuit board can be manufactured by general etching process thereafter.

By employing such a technique, the thickness of the bulk copper layer can be set optionally in the etching line and it is extremely advantageous for the formation of fine pitch lines. Incidentally, that the phase, the electrodeposited copper foil layer only comprising fine copper particles, in this specification is employed only for describing that no bulk layer is contained but not means excluding even the surface testament generally carried out for a copper foil for anti-corrosion layer formation or the like.

Further, claim 8 describes an electrodeposited copper foil with carrier having a three-layer structure composed of a carrier foil layer, an additional metal layer, and an electrodeposited copper foil layer, wherein the carrier foil is of a metal material having a smooth surface with the roughness (Rz) of 4.0 to 20.0 μm, the additional metal layer is a nickel layer with the thickness of 0.05 to 2.0 μm thickness in the matte side of the carrier foil, and the electrodeposited copper foil layer comprising a bulk layer and fine copper particles in the surface of the additional metal layer to be an electrodeposited copper foil with carrier for processing for laser hole formation and claim 9 describes an electrodeposited copper foil with carrier having a three-layer structure composed of a carrier foil layer, an additional metal layer, and an electrodeposited copper foil layer, wherein the carrier foil is of a metal material having a smooth surface with the roughness (Rz) of 4.0 to 20.0 μm, the additional metal layer is a cobalt layer with the thickness of 0.03 to 3.0 μm thickness in the matte side of the carrier foil, and the electrodeposited copper foil layer comprising a bulk layer and fine copper particles in the surface of the additional metal layer to be an electrodeposited copper foil with carrier for processing for laser hole formation.

The electrodeposited copper foils described in claim 8 and claim 9 mean electrodeposited copper foil with carriers each comprising a nickel layer with the thickness of 0.05 to 2.0 μm or a cobalt layer with the thickness of 0.03 to 3.0 μm on the surface of the carrier foil made of a metal having the matte side with 4.0 to 20.0 μm roughness (Rz) and the electrodeposited copper foil positioned in the surface of the cobalt layer and FIG. 10 shows the schematic cross-sectional structure. The copper foils are to be employed for laser processing after being processed to be copper clad laminates and then etched to remove the carrier foils and the shape of the surface of the additional metal layers is affected by the shape of the surface of the carrier foils and the additional metal layers have the transferred roughened surface shapes, or mirror shapes of the carrier foils.

Consequently, the electrodeposited copper foils described in claim 8 and claim 9 after the removal of the carrier foils are similar to the copper foils described in claim 3 and claim 4. Consequently, because of the same reasons described above, the additional metal layers to be formed on the carrier foils of a metal having the matte side with the roughness (Rz) of 4.0 μm to 20.0 μm are required to have the thickness controlled within a range of 0.05 to 2.0 μm thickness in the case of a nickel layer and within a range of 0.03 to 3.0 μm thickness in the case of a cobalt layer. In this case also, the role which the additional metal layers; the nickel layer and the cobalt layer; have to perform at the time of processing by laser beam is same as described in the description of claim 1 and claim 2 and the reason for the restriction of the thickness of the nickel layer and the cobalt layer is also same, so that duplicated explanation is omitted here.

Claim 10 describes an electrodeposited copper foil with carrier having a three-layer structure composed of a carrier foil layer, an additional metal layer, and an electrodeposited copper foil layer, wherein the carrier foil is of a metal material having a matte side with the roughness (Rz) of 4.0 μm 20.0 μm, the additional metal layer is a nickel layer or a cobalt layer with the thickness of 0.03 to 1.0 μm thickness in the matte side of the carrier foil, and the electrodeposited copper foil layer only comprises fine copper particles in the surface of the additional metal layer to be an electrodeposited copper foil with carrier for processing for laser hole formation. FIG. 11 shows the schematic cross-sectional view. The electrodeposited copper foil with carrier is only different from the electrodeposited copper foil with carrier described in claim 7 in the roughness of the face of the carrier foils on which additional metal layers are to be formed. So that, in addition to the effects as described in claim 7, the effect which the roughness of the carrier foil provides is added. The effect caused owing to the utilization of the matte side is same as that described in claim 3 and claim 4 and the description will be duplicated and therefore is omitted.

The reason for the restriction of a carrier foil to a metal material in the electrodeposited copper foil with carriers described in claim 5 to claim 10 is because the means for removing the carrier foil is assumed to be an etching method. Consequently, the reason for taking no organic conductive film or the like into consideration is because no effective means equivalent to the effective etching method effectively capable of swelling and removing the organic film has been found presently.

Consequently, the metal material to be employed for the carrier foil for the electrodeposited copper foil with carriers decried in claim 5 to claim 10 is assumed to be aluminum, copper, and an iron-based alloy. As described in claim 5 and claim 6, in the case where the smooth face of the carrier foil is employed, proper rolled materials of the above-described materials may be employed. The thickness of the carrier foil is not particularly restricted, however the upper limit value is spontaneously to be determined by the manufacture process and the structure of the apparatus employed. In the case where manufacturing is carried out using so-called surface treatment apparatus as described later, the carrier foil itself meanders and moves in a winding manner in the apparatus and for that, it can be said that the upper limit is 210 μm in the case of aluminum and copper and 180 μm in the case of an iron-based alloy taking that the moving state of the meandering carrier foil has to be stabilized and that the carrier foil is finally wound as a product of an electrodeposited copper foil with carrier into consideration.

The reason of the restriction of the lower limit of the thickness of the carrier foil is as follows. The most important role as the above described carrier foil is supposed to support the electrodeposited copper foil layer, especially an extremely thin copper foil layer. Consequently, in order to take the role sufficiently, regardless of the constituent material of the carrier foil, at thinnest 5 μm thickness is supposed to be required.

The copper foils described in claim 5 to claim 7, as described above, are to comprise the carrier foils of a metal having a smooth surface with the roughness (Rz) of 0.05 μm to less than 4.0 μm and the electrodeposited copper foil with carrier described in claim 8 to claim 10, being different from the electrodeposited copper foil with carriers as described in claim 5 to claim 7, are to comprise the carrier foils of a metal having a matte face with the roughness (Rz) of 4.0 μm to less than 20.0 μm. The former roughness range allows usage of the matte sides of electrodeposited copper foils with any thickness from nominal thickness of 12 to 210 μm for the carrier foils. In the case of the latter, taking the above-described relation between the roughness of the matte side of the carrier foils and the reflectance of laser, it is advantageous to use the matte side of electrodeposited copper foils with the nominal thickness of 12 to 70 μm for the carrier foils.

An electrodeposited copper foil is to be manufactured through an electrolytic process and a surface treatment process and an electrodeposited copper foil to be employed for a carrier foil may be usable regardless of the surface treatment for anti-corrosion or the like. An untreated electrodeposited copper foil is manufactured by passing a copper sulfate solution between a drum-shaped rotary cathode and an anode disposed on the opposite to the rotary cathode along the shape of the rotary cathode, depositing copper by the electrolytic reaction on the drum surface of the rotary cathode, continuously peeling the deposit copper in a foil state from the rotary cathode and winding the copper in a foil state. The copper foil in this stage is an untreated copper foil (a deposited foil).

The face of the deposited foil parted from the state being stuck to the rotary cathode has a mirror shaper of the mirror-finished rotary cathode surface, has luster and smooth face and is thus called as the matte side. On the other hand, the surface shape of the surface shape of the deposited foil in the deposited side shows a hill-like convexoconcave shape as shown in FIG. 6 since the crystal growth speed of deposited copper differs for every crystal face and is thus called a matte side. Generally, the matte side is the face to which an insulating material is to be stuck at the time of manufacturing a copper clad laminate.

The matte sides of electrodeposited copper foils formed in such a manner generally have roughness (Rz) of 0.05 μm to 4.2 μm and among them, copper foils having matte sides with roughness (Rz) of 0.05 μm to less than 4.0 μm as described in claim 21 may be selected to be used. Since the matte sides have the transferred face shape of the rotary cathode drum and thus are not affected by the thickness and because of the above-described reasons regarding the thickness of the carrier foils, electrodeposited copper foils with the nominal thickness of 12 to 210 μm predicable by mass production are usable. On the other hand, the matte sides of electrodeposited copper foils generally have the roughness (Rz) of 4.0 to 26.0 μm and among them, the copper foils having the roughness (Rz) of 4.0 μm to 20.0 μm as described in claims may be selected and used. Consequently, any electrodeposited copper foil with any thickness can be usable if they have matte sides in the roughness range, however preferable to be used are electrodeposited copper foils having the nominal thickness of 12 to 70 μm. That is determined taking the above-described reflectance of the matte sides of the copper foils into consideration.

As a manufacturing method of an electrodeposited copper foil with carrier for processing for laser hole formation as described in claim 5 to claim 10 described above, it is preferable to manufacture it using the above-described surface treating apparatus. That is because a carrier foil is generally wound and treating the carrier foil in web state continuously without disconnection is preferable from the production yield point of view.

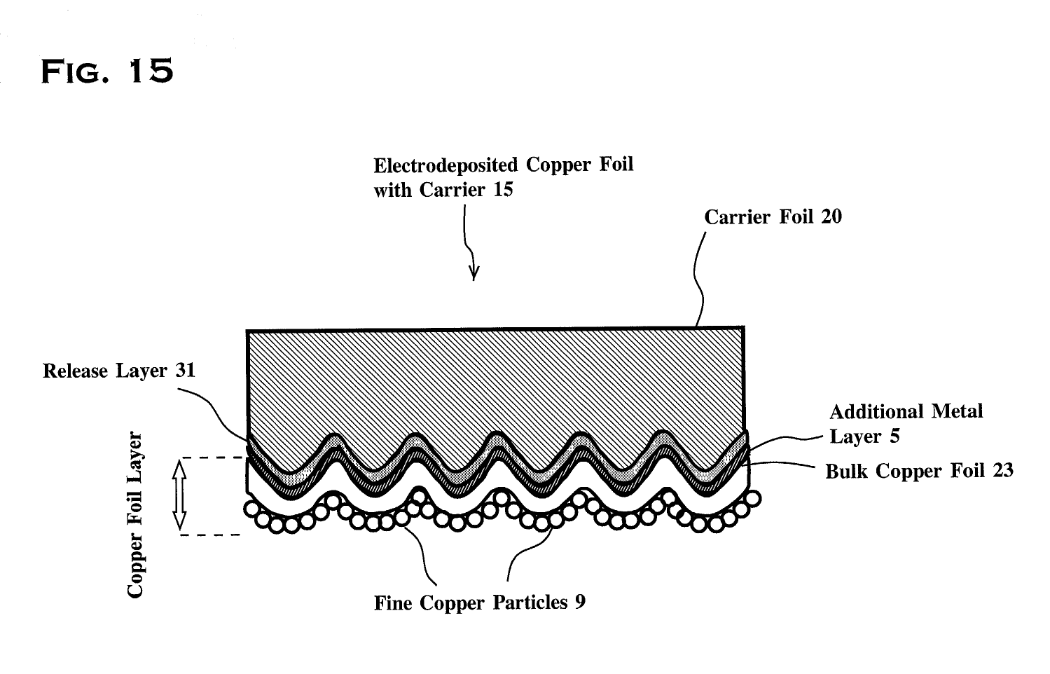

For that, the method selected by inventors of the invention is as follows: a carrier foil rolled in a roll state is unwound in one direction and the copper foil is subjected to the electrodeposited copper foil layer formation process properly equipped with water-rinsing treatment tanks by being passed respectively through an pickling tank, an additional metal layer formation tank, a formation tank for forming a bulk copper layer to be the electrodeposited copper foil layer, a surface nodular treatment tank for forming fine copper particles on the surface of the bulk copper layer, an anti-corrosion treatment tank, and a drying part, which are continuously arranged, to continuously form the additional metal layer and the electrodeposited copper foil layer on the carrier foil. Practically the process is as shown in the schematic cross-sectional figure of the surface treating apparatus illustrated in FIG. 12.

To explain along the arrangement order of the tanks, since the pickling tank is same as explained in the manufacture method of the copper foils described in claim 1 and claim 4, the explanation is omitted. Further, the additional metal layer formation tank for forming an additional metal layer on the surface of a carrier foil and the solutions to be employed for the additional metal layer formation are also similar to those described above, so that the description to be duplicated is omitted.

On the completion of the additional metal layer formation, a bulk copper layer formation is continuously be carried out on the additional metal layer. In the formation tank of bulk copper, any solution is usable as a copper ion supply source such as a copper sulfate type solution, a copper pyrophosphate type solution and the like and is not particularly restricted. For example, in the case of using a copper sulfate solution, conditions are as the copper concentration of 30 to 100 g/l, sulfuric acid of 50 to 200 g/l, the solution temperature is 30 to 80° C., and the current density is 1 to 100 A/dm² and in the case of using copper pyrophosphate solution, conditions are as the copper concentration of 10 to 50 g/l, potassium pyrophosphate of 100 to 700 g/l, the solution temperature is 30 to 60° C., pH of 8 to 12, and the current density is 1 to 10 A/dm². In this case, a carrier foil bearing an additional metal layer being immersed in a proper solution and an anode is installed parallel to face side of the carrier foil bearing the additional metal layer and the carrier foil itself is cathode-polarized to evenly and smoothly plate the copper component to form the bulk copper layer on the additional metal layer. Hereafter, for the tank employing the electrodeposition, those equipped with a similarly installed anode are employed.

In this case, if bulk copper is not formed in the formation tank for the bulk copper layer, it is easy to obtain an electrodeposited copper foil with carrier for processing for laser hole formation as described in claim 7, which comprises only fine copper particles as an electrodeposited copper foil on the carrier foil.

Then, on completion of the bulk copper layer formation, as a process for forming fine copper particles on the surface of the bulk copper layer, the resulting carrier foil is led to a surface-nodular treatment tank. If the bulk copper is not formed, fine copper particles are to be formed directly on the additional metal layer. The treatment carried out in the surface-nodular treatment tank and conditions, the contents of the anti-corrosion treatment and the drying process are same as those in the case of manufacturing the surface treated copper foils as described in claim 1 to claim 4, so that detailed description here is omitted.

Then, the description given is regarding peelable electrodeposited copper foil with carriers for processing laser hole formation as described in claim 11 to claim 16. Claim 11 describes an electrodeposited copper foil with carrier composed of a carrier foil, a release layer formed on the surface of the carrier foil, and an additional metal layer and an electrodeposited copper foil layer formed on the release layer, wherein the carrier foil is of a film or a metal material having a smooth surface with the roughness (Rz) of 0.05 to less than 4.0 μm, the release layer is formed using an organic agent or a metal material on the smooth face side of the carrier foil, a nickel layer with the thickness of 0.08 to 2.0 μm thickness is formed as the additional metal layer on the surface of the release layer, and the electrodeposited copper foil layer comprising a bulk layer and fine copper particles is formed in the surface of the additional metal layer to be an electrodeposited copper foil with carrier for processing for laser hole formation. The schematic cross-sectional view is illustrated in FIG. 13.

Claim 12 describes an electrodeposited copper foil with carrier composed of a carrier foil, a release layer formed on the surface of the carrier foil, and an additional metal layer and an electrodeposited copper foil layer formed on the release layer, wherein the carrier foil is of a film or a metal material having a smooth surface with the roughness (Rz) of 0.05 to less than 4.0 μm, the release layer is formed using an organic agent or a metal material on the smooth face side of the carrier foil, a cobalt layer with the thickness of 0.05 to 3.0 μm thickness is formed as the additional metal layer on the surface of the release layer, and the electrodeposited copper foil layer comprising a bulk layer and fine copper particles is formed in the surface of the additional metal layer to be an electrodeposited copper foil with carrier for processing for laser hole formation. The schematic cross-sectional view is illustrated in FIG. 13.

Claim 13 describes an electrodeposited copper foil with carrier composed of a carrier foil, a release layer formed on the surface of the carrier foil, and an additional metal layer and an electrodeposited copper foil layer formed on the release layer, wherein the carrier foil is of a film or a metal material having a smooth surface with the roughness (Rz) of 0.05 to less than 4.0 μm, the release layer is formed using an organic agent or a metal material on the smooth face side of the carrier foil, a nickel layer or a cobalt layer with the thickness of 0.03 to 1.0 μm is formed as the additional metal layer on the surface of the release layer, and the electrodeposited copper foil layer comprising only fine copper particles is formed in the surface of the additional metal layer to be an electrodeposited copper foil with carrier for processing for laser hole formation, which is an electrodeposited copper foil with carrier having no bulk layer. The schematic cross-sectional view is illustrated in FIG. 14.

Claim 14 describes an electrodeposited copper foil with carrier composed of a carrier foil, a release layer formed on the surface of the carrier foil, and an additional metal layer and an electrodeposited copper foil layer formed on the release layer, wherein the carrier foil is of a film or a metal material having a matte side with the roughness (Rz) of 4.0 μm to 20.0 μm, the release layer is formed using an organic agent or a metal material on the matte side of the carrier foil, a nickel layer with the thickness of 0.05 to 2.0 μm thickness is formed as the additional metal layer on the surface of the release layer, and the electrodeposited copper foil layer comprising a bulk layer and fine copper particles is formed in the surface of the additional metal layer to be an electrodeposited copper foil with carrier for processing for laser hole formation. The schematic cross-sectional view is illustrated in FIG. 15.

Claim 15 describes an electrodeposited copper foil with carrier composed of a carrier foil, a release layer formed on the surface of the carrier foil, and an additional metal layer and an electrodeposited copper foil layer formed on the release layer, wherein the carrier foil is of a film or a metal material having a matte side with the roughness (Rz) of 4.0 μm 20.0 μm, the release layer is formed using an organic agent or a metal material on the matte side of the carrier foil, a cobalt layer with the thickness of 0.03 to 3.0 μm thickness is formed as the additional metal layer on the surface of the release layer, and the electrodeposited copper foil layer comprising a bulk layer and fine copper particles is formed in the surface of the additional metal layer to be an electrodeposited copper foil with carrier for processing for laser hole formation. The schematic cross-sectional view is illustrated in FIG. 15.

Claim 16 describes an electrodeposited copper foil with carrier composed of a carrier foil, a release layer formed on the surface of the carrier foil, and an electrodeposited copper foil layer formed on the release layer, wherein the carrier foil is of a film or a metal material having a matte side with the roughness (Rz) of 4.0 μm 20.0 μm, the release layer is formed using an organic agent or a metal material on the matte side of the carrier foil, a nickel layer or a cobalt layer with the thickness of 0.03 to 1.0 μm is formed as the additional metal layer on the surface of the release layer, and the electrodeposited copper foil layer comprising only fine copper particles is formed in the surface of the cobalt layer to be an electrodeposited copper foil with carrier for processing for laser hole formation. The schematic cross-sectional view is illustrated in FIG. 16.

As being made clear from the description described above, the electrodeposited copper foil with carriers for processing for laser hole formation of claim 11 to claim 16 are different from the electrodeposited copper foil with carriers for processing for laser hole formation of claim 5 to claim 10 in the point that the release layers using organic agents are formed in the interface between the carrier foils and the additional metal layers. Consequently, the supposed meaning of the carrier foils, the assumed roles of the additional metal layers of nickel or cobalt, the meanings of the numeral values of the thickness in the ranges, and the meaning of the formation of the electrodeposited copper foil layers comprising only the fine copper particles are same and therefore the description to be duplicated is omitted.

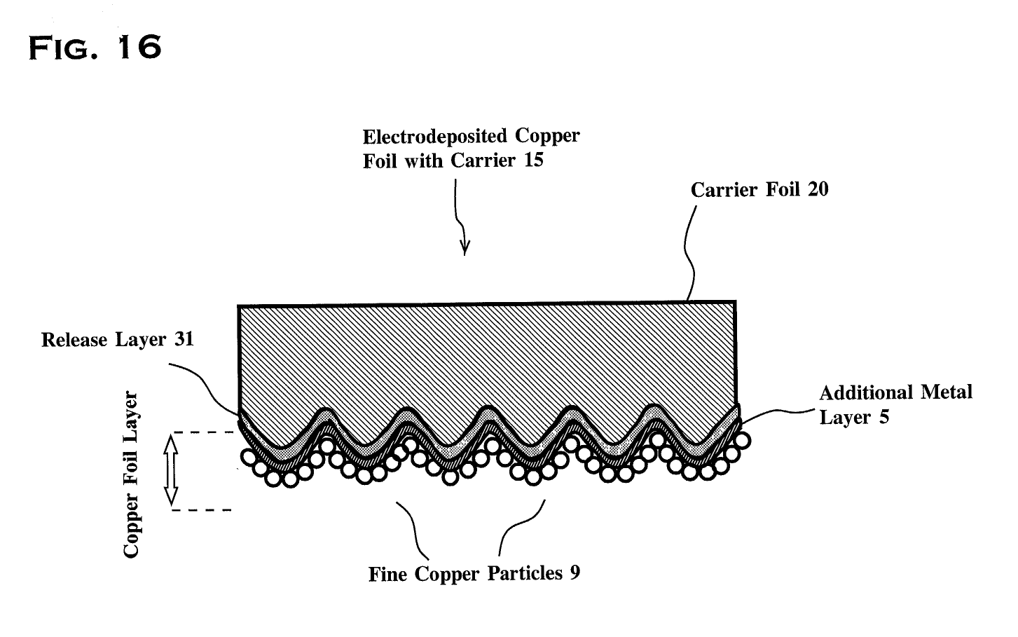

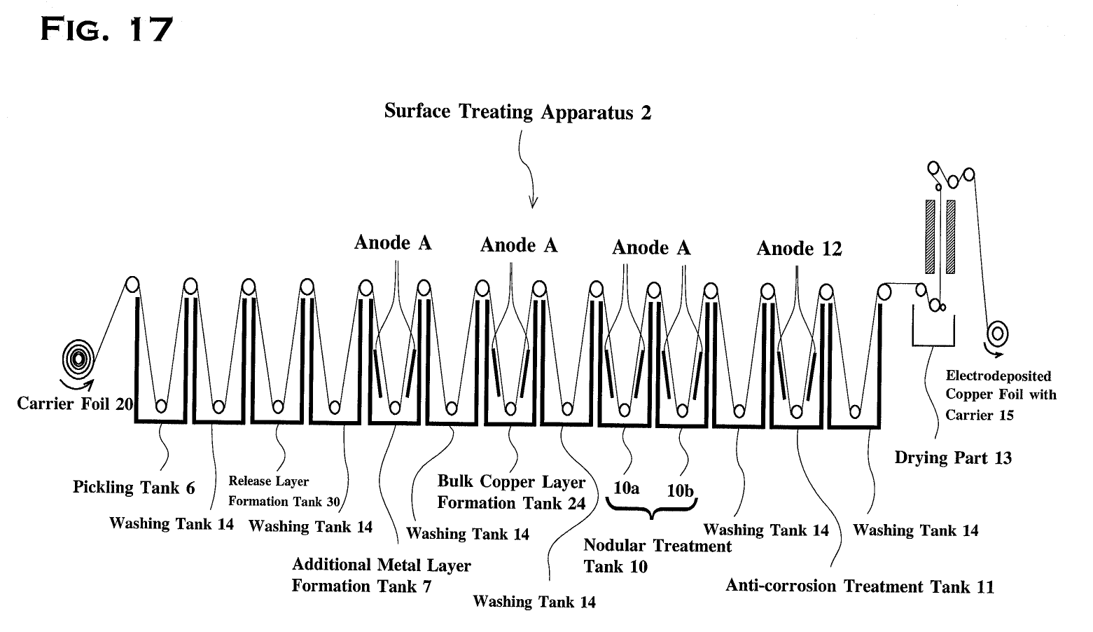

Also, regarding the manufacturing method of copper foils described in claim 11 to claim 16, the point different from the manufacturing method of the copper foils described in claim 5 to claim 10 is only that the organic release layers are formed after pickling of the carrier foils to form the organic junction interfaces and then the additional metal layers are formed. According to that, a manufacturing method for an electrodeposited copper foil with carrier described in claims is a manufacturing method of an electrodeposited copper foil with carrier comprising steps of unwinding a carrier foil rolled in a roll state in one direction and subjecting the carrier foil to the electrodeposited copper foil layer formation process properly equipped with water-rinsing treatment tanks by passing the carrier foil respectively through an pickling tank, a release layer formation tank, an additional metal layer formation tank, a formation tank for forming a bulk copper layer to be the electrodeposited copper foil layer, a surface nodular treatment tank for forming fine copper particles on the surface of the bulk copper layer, an anti-corrosion treatment tank, and a drying part, which are continuously arranged, to continuously form the release layer of an organic type agent and the electrodeposited copper foil layer on the carrier foil. The flow of the manufacturing method is illustrated in FIG. 17.

In the case where a junction interface is formed using a metal material for the release layer, a method preferable to be employed is an electrodeposition method for depositing zinc of about 500 to 1,500 mg per 1 m² of a carrier foil to form a zinc layer. That is because it is easy to stably and reliably retain the releasing strength as compared with other cases of using different types of metals. However, the release layer using the metal material is inferior in the stable releasing strength between a carrier foil and an additional metal layer as compared with a release layer using an organic agent, which will be described below.

To use an organic agent for formation of the junction interface makes it possible to stabilize the releasing strength of the interface between the carrier foil and the additional metal layer in a low level and to control the releasing strength of the carrier foil to the level low enough to easily peel the foil by manual work by a man after the high temperature hot pressing in the copper clad laminate manufacture. Moreover, it is possible to completely avoid the satiation that peeling is impossible or eliminate the defective peeling that segments remain in the copper foil surface after peeling, which are sometimes observed in the case of a conventional one in which a metal type material is used for the release layer.

As described in claims, the organic agent here is preferably 1 or more compounds selected from nitrogen-containing organic compounds, sulfur-containing organic compounds, and carboxylic acids.

Among the nitrogen-containing organic compounds, the sulfur-containing organic compounds, and the carboxylic acids, the nitrogen-containing organic compounds include nitrogen-containing organic compounds having substituent groups. Practically, preferable to be used as the nitrogen-containing organic compounds are triazole compounds having substituent groups such as 1,2,3-benzotriazole (hereafter referred as to BTA), carboxybenzotriazole (hereafter referred as to CBTA), N′,N′-bis(benzotriazolemethyl)urea (hereafter referred as to BTD-U), 1H-1,2,4-triazole (hereafter referred as to TA), 3-amino-1H-1,2,4-triazole (hereafter referred as to ATA), and the like.

Preferable to be used as the sulfur-containing organic compounds are mercaptobenzothiazole (hereafter referred as to MBT), thiocyanuric acid (hereafter referred as to TCA), 2-benzimidazolethiol (hereafter referred as to BIT) and the like.

As the carboxylic acids, especially preferable to be employed are monocarboxylic acids and among them, oleic acid, lenoleic acid, linolenic acid and the like are preferable to be used.

The use method of the above described organic agents will be described while explaining the formation method of an release layer on a carrier foil. The formation of a release layer on a carrier foil can be carried out using the above-described organic agents melted in a solvent and immersing the carrier foil in the resulting solvent or by a showering, spraying, dropwise titrating or electrodepositing method to the face where the release layer is to be formed and there is no need to employ any restricted technique. The concentration of the organic agents in the solvent is preferably in a range of 0.01 g/l to 10 g/l for all of the above-described organic agents and the solution temperature is preferably in a range of 20 to 60° C. The concentration of the organic agents is not specifically restricted and the concentration is generally no problem if it is high or low.

The formation of the release layer using an organic agent may be carried out, as described in claims, using a solution in which one or more compounds selected from the nitrogen-containing organic compounds, the sulfur-containing organic compounds, and the carboxylic acids or, as described in claims, applying one of organic agents or a mixture of two or more organic agents selected from the nitrogen-containing organic compounds, the sulfur-containing organic compounds, and carboxylic acids repeatedly a plurality of times. In such a manner, the thickness of the release layer can be controlled highly precisely.

From the formation principle of the release layer, the above-described organic agents are supposed to stably exist in the surface of a carrier foil because of the following reasons. For example, in the case of forming a release layer of an organic agent on a carrier foil of a metal, the organic agent is adsorbed on an oxidized additional metal layer, which is an metal oxide coating film formed on the surface of the carrier foil. Then, from such a state that the organic agent is adsorbed in the oxidized additional metal layer, it is assumed that the organic agent is bonded with a coupler such as oxygen existing in the surface layer to stabilize the organic agent forming the release layer. Consequently, it can be said that the concentration of the organic agent is higher, the speed of the adsorption of the organic agent on the surface of the carrier foil is increased more and the concentration of the organic agent is basically determined according to the speed of the manufacturing line. The duration for contacting the carrier foil and the organic agent melted in a solvent is also determined by the speed of the manufacturing line and practically it is about 5 to 60 second contacting time.

Taking these factors into consideration, if the concentration of the organic agent is lower than 0.01 g/l, which is the lower limit value, the adsorption of the agent in the surface of the carrier foil within a short time becomes difficult and the thickness of the release layer to be formed becomes uneven and stabilization of the quality of products is made impossible. On the other hand, even if the concentration exceeds 10 g/l, which is the upper limit value, the adsorption speed of the organic agent in the surface of the carrier foil is not particularly increased corresponding to the increase of the addition amount and therefore it is not preferable in terms of the production cost.

To use the above-described organic agents makes the quantitative control easy at the time of release layer formation and makes it possible to keep the junction strength of the carrier foil and an electrodeposited copper foil equipped with a additional metal layer within a specified range. Moreover, it is also made possible to provide excellent thermal stability and reliably retain stable releasing strength after pressing.

At the time of peeling a carrier foil and an electrodeposited copper foil from each other, an organic agent is transferred as an organic agent film to the surface of an additional metal layer, it also functions as an anti-corrosion layer of the electrodeposited copper foil. The organic film can be removed easily be pickling with a solution such as a diluted sulfuric acid solution, a diluted hydrochloric acid and the like and does not cause any bad effect in the manufacturing process of a printed circuit board.

These organic agents are generally not conductive materials but materials having an insulating property. Consequently, the electrodeposited copper foil with carrier according to claim 11 to claim 16 are required to comprise the carrier foil itself polarized as a cathode, to be capable to directly electrodeposite copper on the release layer of the organic agents formed on the carrier foil and to be electrically conductive through the release layer. That is, the thickness of the release layer of the organic agents is naturally restricted and should be proper to keep the proper releasing strength and also stably carry out electrodeposition of copper.

Consequently, it is not so important what kind of a release layer is formed using which solvent to melt the organic agent in which concentration and how long duration the treatment is carried out, but the thickness of the consequently formed release layer, in other words, the quantity of the organic agents existing in the release layer is important. Regarding that, claims clarify the thickness of the release layer formed using an organic agent is preferable to be in a range of 1 nm to 1 μm.

Within the clarified range, the proper releasing strength is made possible to be retained and copper can be electrodeposited stably. That is, if the quantity (the thickness) of the organic agent used for the release layer is less than 1 nm thick, which is the lower limit value, the thickness of the release layer of the organic agent becomes uneven and no uniform release layer is formed. As a result, stable and proper releasing strength cannot be obtained after the hot pressing and in some cases, the carrier foil cannot be released.

If the thickness exceeds 1 μm, which is the upper limit value, the electric connection state becomes unstable and thus the copper deposition becomes unstable to make it difficult to form an electrodeposited copper foil layer with a uniform thickness. Further, even if copper is deposited for a long duration, the releasing strength cannot be so high to satisfy the minimum necessary strength as to safely finish the hot pressing. If the thickness of the release layer is further thicker, electric connection becomes completely impossible.

Since the thickness of the release layer is as extremely thin as nm to μm level, the measurement of the thickness is made possible by using a transmission electron microscope, a quantitative chemical analysis, or a surface resistance measurement method.

The term, the proper releasing strength, employed in the specification means that the value measured according to JIS-C-6481 is within a range of 1 to 300 gf/cm. That is the range calculated by taking the practical use achievement of conventional peelable electrodeposited copper foil with carriers into consideration and additionally considering the ideally required value for a use of the electrodeposited copper foil with carriers to the strength for peeling (the releasing strength) supposed to be proper from the experiences in the interface between a carrier foil and an electrodeposited copper foil. As the releasing strength in the interface between a carrier foil and an electrodeposited copper foil is lower, the peeling work is made easier. However, if the releasing strength is less than 1 gf/cm, at the time of handling an electrodeposited copper foil with carrier in the manufacture and manufacturing a copper clad laminate, a carrier foil and an electrodeposited copper foil are spontaneously partially parted from each other and blistered to cause defects of such as positioning error. On the other hand, if the releasing strength exceeds 300 gf/cm, it becomes difficult to easily peel the carrier foil, which is one of the characteristics of the present invention, and a technique requiring to use a specific peeling apparatus is needed at the time of peeling.

To use the electrodeposited copper foil with carrier as described in claim 11 to claim 16 makes it easy to release carrier foils from copper clad laminates after the copper clad laminate are manufactured. Consequently, these claims describe copper clad laminates obtained using the electrodeposited copper foil with carriers as described in claim 5 to claim 4 and are capable of providing the same effect as that the case of using the surface treated copper foils described in claim 1 to claim 4 after the carrier foils are released and of effectively lowering the manufacturing cost of printed circuit boards for fine pitch circuits.

### PREFERRED EMBODIMENTS OF THE INVENTION

Description given along with examples below is regarding a surface treated copper foil for processing for laser hole formation and a manufacturing method of an electrodeposited copper foil with carrier according to the invention and the results of laser hole formation. Incidentally, the laser hole formation test was carried out using pulsed energy as low as 16 mJ so as to make the excellency in laser hole formability more clear. The laser radiation conditions were controlled as follows in all of the following examples so as to form holes with 110 μm hole diameter in copper clad laminate using carrier foils with a variety of thickness values; the frequency of 2,000 Hz, the mask diameter of 5.0 mm, the pulse width of 60 )sec., the pulsed energy 16.0 mJ (in the examples 1 to 4, 20.0 mJ), the offset of 0.8, and laser beam diameter of 140 μm. Consequently, inventors of invention determined that the processing was excellent carried out if the hole diameter after processing was within a range of 100 to 110 μm as a specification. Further, if same symbols are possible to be employed for those in common, the same symbols are assigned for them in common in the examples as much as possible.

### EXAMPLE 1

In this example, a surface treated copper foil 1 according to claim 1 will be described. The surface treating apparatus 2 employed here was that illustrated in FIG. 7 and was a type where an unwound deposited foil 3 for manufacturing a copper foil with a nominal thickness of 9 μm was moved in a winding manner through the respective tanks of the manufacturing apparatus 2. Here, an additional metal layer 5 using nickel with the thickness of 1 μm was formed in the shiny side 4 of the deposited foil 3. Hereafter, the manufacturing conditions will be described in the order of the respective types of the tanks continuously arranged in series.

The unwound deposited foil 3 entered at first to an pickling tank 6. The inside of the pickling tank 6 was filled with a diluted sulfuric acid solution of 150 g/l concentration and at 30° C. solution temperature and the oils and fats adhering to the deposited foil 3 were removed for immersion time of 30 seconds and the surface oxidized film was removed.

The deposited foil 3 coming out of the pickling tank 6 entered an additional metal layer formation tank 7. The additional metal layer formation tank 7 was filled with a solution containing nickel sulfate in nickel concentration of 20 g/l and at 40° C. solution temperature and pH of 3 and the deposited foil 3 itself was polarized to be a cathode and electrolysis was carried out at 8 A/dm² current density to form a nickel layer with the thickness of 1 μm as the additional metal layer 5 on the shiny side 4 of the deposited foil 3. At that time, an anode A of a flat plate was set in parallel to the shiny side 4 of the deposited foil 3 at an interval as illustrated in FIG. 17.

On completion of the formation of the additional metal layer 5, in order to successively carry out nodular treatment for the matte side 8 of the deposited foil 3, the deposited foil 3 was led to a nodular treatment tank 10 for the process of forming fine copper particles 9 on the matte side 8 of the deposited foil 3. The treatment carried out in the nodular treatment tank 10 comprised a process 10a for depositing and sticking the fine copper particles 9 on the matte side 8 of the deposited foil 3 and a seal plating process lob for preventing the dropping of the fine copper particles 9.

In the process 10a for depositing and sticking the fine copper particles 9 on the matte side 8, electrolysis was carried out for 10 seconds in an copper sulfate solution in burn plating conditions; sulfuric acid concentration of 100 g/l, copper of 18 g/l, the solution temperature of 25° C., and the current density of 10 A/dm². At that time, the anode A of a flat plate was installed in parallel to the matte side 8 of the deposited foil 3 as illustrated in FIG. 7 at an interval.

In the seal plating process 10b for preventing the dropping of the fine copper particles 9, electrolysis was carried out for 20 seconds in an copper sulfate solution in level plating conditions; sulfuric acid concentration of 150 g/l, copper of 65 g/l, the solution temperature of 45° C., and the current density of 15 A/dm². At that time, the anode A of a flat plate was installed in the same manner as that in the process 10a for depositing and sticking the fine copper particles 9.

In an anti-corrosion treatment tank 11, using zinc as an anti-corrosion element, anti-corrosion treatment was carried out for the matte side in which the fine copper particles were deposited and formed. At that time, an anode 12 made of a zinc plate was used as an anode to keep the concentration balance of zinc in the anti-corrosion treatment tank 11. The plating conditions in this case was as follows: using a zinc sulfate bath and sulfuric acid concentration of 70 g/l, the zinc concentration of 20 g/l, the solution temperature of 40° C., and the current density of 15 A/dm². At that time, the anode 12 made of a flat plate was installed in parallel to the matte side 8 of the deposited foil 3 as illustrated in FIG. 7 at an interval.

When the anti-corrosion treatment was finished, the deposited foil 3 was finally passed through the inside of a furnace heated at 110° C. ambient temperature by an electric heater in a drying part 13 for 40 seconds and rolled in a roll state as a completed surface treated copper foil 1. Between the processes in the respective tanks, washing tanks 14 capable of washing with water for 15 seconds were installed to carry out washing and prevent the solutions of the previous treatment processes from causing contamination.

A copper clad laminate was manufactured using the resulting surface treated copper foil as the outer layer copper foil of the four-layered board, and the processibility for laser hole formation was investigated. Via-hole formation was carried out by laser and the laser radiation conditions were as described in the beginning and a 100-shot laser processing test for via-hole formation was carried out to achieve 100% opening ratio (in the description above and the description below, it means the ratio capable to form holes by laser hole formation processing) with opening diameter distribution of 103 to 108 μm without any openings smaller than 100 μm diameter.

### EXAMPLE 2

In this example, a surface treated copper foil 1 according to claim 2 will be described. The surface treating apparatus 2 employed here was that illustrated in FIG. 7 and was a type where an unwound deposited foil 3 for manufacturing a copper foil with a nominal thickness of 9 μm was moved in a winding manner through the respective tanks of the manufacturing apparatus 2. Here, an additional metal layer 5 using cobalt with the thickness of 1 μm was formed in the shiny side 4 of the deposited foil 3. Hereafter, the manufacturing conditions will be described in the order of the respective types of the tanks continuously arranged in series, however since only the solution filling the inside of the additional metal layer formation tank 7 was different and other than that, the rest were same as those in the example 1, the description of the common portions is omitted and only the different portion will be described.

The unwound deposited foil 3 coming out of the pickling tank 6 entered an additional metal layer formation tank 7. The additional metal layer formation tank 7 was filled with a solution containing cobalt sulfate and electrolysis was carried out in the conditions; the cobalt concentration of 20 g/l, trisodium citrate of 200 g/l, the solution temperature of 35° C., pH of 3, and the current density of 7 A/dm²; to form a cobalt layer with 1 μm thickness as an additional metal layer 8 on the shiny side 4 of the deposited foil 3. Other manufacturing conditions were same as those in the example 1.

A copper clad laminate was manufactured using the resulting surface treated copper foil 1 as the outer layer copper foil of the four-layered board, and the processibility for laser hole formation was investigated. Via-hole formation was carried out by laser and the laser radiation conditions were as described in the beginning and a 100-shot laser processing test for via-hole formation was carried out to achieve 100% opening ratio with opening diameter distribution of 105 to 111 μm without any openings smaller than 100 μm diameter.

### EXAMPLE 3

In this example, a surface treated copper foil 1 according to claim 3 will be described. The surface treating apparatus 2 employed here was that illustrated in FIG. 7 and was a type where an unwound deposited foil 3 for manufacturing a carrier foil with a nominal thickness of 9 μm was moved in a winding manner through the respective tanks of the manufacturing apparatus 2. Here, an additional metal layer 5 using nickel with the thickness of 1 μm was formed in the matte side 8 side of the deposited foil 3.

Hereafter, the manufacturing conditions will be described in the order of the respective types of the tanks continuously arranged in series, however since the manufacturing conditions were completely same as described in the case of the example 1, the description of the common portions is omitted and only the different portion will be described. The difference was that the way of unwinding the deposited foil 3 in the surface treating apparatus 2 was changed and the surface of the copper foil moving in the surface treating apparatus 2 were reversed to those in the case of the example 1. In such a manner an additional metal layer 5 was formed in the matte side 8 side of the deposited foil 3 and fine copper particles were deposited and formed in the shiny side 4.

A copper clad laminate was manufactured using the resulting surface treated copper foil 1 obtained in such a manner as the outer layer copper foil of the four-layered board, and the processibility for laser hole formation was investigated. Via-hole formation was carried out by laser and the laser radiation conditions were as described in the beginning and a 100-shot laser processing test for via-hole formation was carried out to achieve 100% opening ratio with opening diameter distribution of 105 to 110 μm without any openings smaller than 100 μm diameter.

### EXAMPLE 4

In this example, a surface treated copper foil 1 according to claim 4 will be described. The surface treating apparatus 2 employed here was that illustrated in FIG. 7 and was a type where an unwound deposited foil 3 for manufacturing a copper foil with a nominal thickness of 9 μm was moved in a winding manner through the respective tanks of the manufacturing apparatus 2. Here, an additional metal layer 5 using cobalt with the thickness of 1 μm was formed in the matte side 8 side of the deposited foil 3.

Hereafter, the manufacturing conditions will be described in the order of the respective types of the tanks continuously arranged in series, however since the manufacturing conditions were completely same as described in the case of the example 2, the description of the common portions is omitted and only the different portion will be described. The difference was that the way of unwinding in the surface treating apparatus 2 was changed and the surface of the copper foil moving in the surface treating apparatus 2 were reversed to those in the case of the example 2. In such a manner an additional metal layer 5 was formed in the matte side 8 side of the deposited foil 3 and fine copper particles were deposited and formed in the shiny side 4.

A copper clad laminate was manufactured using the resulting surface treated copper foil 1 obtained in such a manner as the outer layer copper foil of the four-layered board, and the processibility for laser hole formation was investigated. Via-hole formation was carried out by laser and the laser radiation conditions were as described in the beginning and a 100-shot laser processing test for via-hole formation was carried out to achieve 100% opening ratio with opening diameter distribution of 105 to 108 μm without any openings smaller than 100 μm diameter.

### EXAMPLE 5

In this example, an electrodeposited copper foil with carrier 15 according to claim 5 will be described. The surface treating apparatus 2 employed here was that illustrated in FIG. 12 and was a type where an unwound carrier foil 20 was moved in a winding manner through the respective tanks of the surface treating apparatus 2. Here, a deposited foil classified in grade 3 of 18 μm thickness was used as the carrier foil 20 and a nickel layer with the thickness of 1 μm was formed as an additional metal layer 5 in the shiny side 4 to form an electrodeposited copper foil layer 21 with the thickness of 3 μm. Hereafter, the manufacturing conditions will be described in the order of the respective types of the tanks continuously arranged in series.

The unwound carrier foil 20 entered at first to an pickling tank 6. The inside of the pickling tank 6 was filled with a diluted sulfuric acid solution of 150 g/l concentration and at 30° C. solution temperature and the oils and fats adhering to the carrier foil 20 were removed for immersion time of 30 seconds and the surface oxidized film was removed.

The carrier foil 20 coming out of the pickling tank 6 entered an additional metal layer formation tank 7 where an additional metal layer 5 was to be formed in the shiny side 4 of the carrier foil 20. The additional metal layer formation tank 7 was filled with a solution containing nickel sulfate in nickel concentration of 20 g/l and at 40° C. solution temperature and pH of 3 and the carrier foil 20 itself was polarized to be a cathode and electrolysis was carried out at 8 A/dm² current density to form a nickel layer with the thickness of 1 μm as the additional metal layer 5 on the shiny side 4 of the carrier foil 20. At that time, an anode A of a flat plate was set in parallel to the shiny side 4 of the carrier foil 20 at an interval as illustrated in FIG. 12.

On completion of the formation of the additional metal layer 5, a bulk copper layer 23 of an electrodeposited copper foil layer 21 was to be formed thereon. The inside of a bulk copper layer formation tank 24 is filled with a copper sulfate solution with sulfuric acid concentration of 150 g/l, copper of 65 g/l, and the solution temperature of 45° C. While the carrier foil 20 bearing the additional metal layer 5 being passed through, the copper component to form the bulk copper layer 23 was evenly and smoothly deposited on one side of the carrier foil 20 bearing the additional metal layer 5. As illustrated in FIG. 11, the anode A of a flat plate was installed in parallel at an interval and the carrier foil 20 itself was polarized to be a cathode to carry out electrolysis so as to form the bulk copper layer 23 with the thickness of 3 μm in level plating condition of the current density of 15 A/dm².

On completion of the formation of the bulk copper layer 23, as the process of forming fine copper particles 9 on the surface of the bulk copper layer 23, the carrier foil 20 was led to a nodular treatment tank 10. The treatment to be carried out in the nodular treatment tank 10 was composed of a process 10a for depositing and sticking the fine copper particles 9 on the bulk copper layer 23 and a seal plating process 10b for preventing the dropping of the fine copper particles 9.

In the process 10a for depositing and sticking the fine copper particles 9 on the bulk copper layer 23, electrolysis was carried out for 10 seconds in the copper sulfate solution same as that used in the above-described bulk copper layer formation tank 24 in burn plating conditions; sulfuric acid concentration of 100 g/l, copper of 18 g/l, the solution temperature of 25° C., and the current density of 10 A/dm². At that time, the anode A of a flat plate was installed in parallel to the face of the carrier foil 20, where the bulk copper layer 23 was formed, as illustrated in FIG. 12 at an interval.

In the seal plating process 10b for preventing the dropping of the fine copper particles 9, electrolysis was carried out for 20 seconds in the copper sulfate solution same as that used in the above-described bulk copper layer formation tank 24 in level plating conditions; sulfuric acid concentration of 150 g/l, copper of 65 g/l, the solution temperature of 45° C., and the current density of 15 A/dm². At that time, the anode A of a flat plate was installed in the same manner as that in the process 10a as to be parallel to the face of the carrier foil 20, where the fine copper particles 9 were deposited and formed, at an interval as illustrated in FIG. 12.

In an anti-corrosion treatment tank 11, using zinc as an anti-corrosion element, anti-corrosion treatment was carried out. At that time, an anode 12 made of a zinc plate was used as an anode to keep the concentration balance of zinc in the anti-corrosion treatment tank 11. The plating conditions in this case was as follows: using a zinc sulfate bath and sulfuric acid concentration of 70 g/l, the zinc concentration of 20 g/l, the solution temperature of 40° C., and the current density of 15 A/dm².

When the anti-corrosion treatment was finished, the carrier foil 20 was finally passed through the inside of a furnace heated at 110° C. ambient temperature by an electric heater in a drying part 13 for 40 seconds and rolled in a roll state as a completed electrodeposited copper foil with carrier 1. Between the processes in the respective tanks, washing tanks 14 capable of washing with water for 15 seconds were installed to carry out washing and prevent the solutions of the previous treatment processes from causing contamination.

A copper clad laminate was manufactured using the resulting electrodeposited copper foil with carrier obtained in such a manner as the outer layer copper foil of the four-layered board, and the processibility for laser hole formation was investigated. To remove the carrier foil, an alkaline copper-etching solution was used for removing the copper component used for the carrier foil while the damage of the nickel layer being suppressed to the minimum level. After the carrier foil removal, via-hole formation was carried out by laser and the laser radiation conditions were as described in the beginning and a 100-shot laser processing test for via-hole formation was carried out to achieve 100% opening ratio with opening diameter distribution of 107 to 113 μm without any openings smaller than 100 μm diameter.

### EXAMPLE 6

In this example, an electrodeposited copper foil with carrier 15 according to claim 6 will be described. The surface treating apparatus 2 employed here was that illustrated in FIG. 12 and was a type where an unwound carrier foil 20 was moved in a winding manner through the respective tanks of the surface treating apparatus 2. Here, a deposited foil classified in grade 3 of 18 μm thickness was used as the carrier foil 20 and a cobalt layer with the thickness of 1 μm was formed as an additional metal layer 5 in the shiny side 4 to form an electrodeposited copper foil layer 21 with the thickness of 3 μm. Hereafter, the manufacturing conditions will be described in the order of the respective types of the tanks continuously arranged in series, however since only the solution filling the inside of the additional metal layer formation tank 7 was different and other than that, the rest were same as those in the example 5, the description of the common portions is omitted and only the different portion will be described.

The deposited foil 3 coming out of the pickling tank 6 entered an additional metal layer formation tank 7. The additional metal layer formation tank 7 was filled with a solution containing cobalt sulfate and electrolysis was carried out in the conditions; the cobalt concentration of 20 g/l, trisodium citrate of 200 g/l, the solution temperature of 35° C., pH of 3, and the current density of 8 A/dm²; to form a cobalt layer with 1 μm thickness as an additional metal layer 8 on the shiny side 4 of the carrier foil 20. Other manufacturing conditions were same as those in the example 1.

A copper clad laminate was manufactured using the resulting electrodeposited copper foil with carrier 15 obtained in such a manner as the outer layer copper foil of the four-layered board, and the processibility for laser hole formation was investigated. To remove the carrier foil, an alkaline copper-etching solution was used for removing the copper component used for the carrier foil while the damage of the cobalt layer being suppressed to the minimum level. After the carrier foil removal, via-hole formation was carried out by laser and the laser radiation conditions were as described in the beginning and a 100-shot laser processing test for via-hole formation was carried out to achieve 100% opening ratio with opening diameter distribution of 108 to 112 μm without any openings smaller than 100 μm diameter.

### EXAMPLE 7

In this example, an electrodeposited copper foil with carrier 15 according to claim 7 will be described. The surface treating apparatus 2 employed here was that illustrated in FIG. 12 and was a type where an unwound carrier foil 20 was moved in a winding manner through the respective tanks of the surface treating apparatus 2. Here, a deposited foil classified in grade 3 of 18 μm thickness was used as the carrier foil 20 and a nickel layer with the thickness of 1 μm was formed as an additional metal layer 5 in the shiny side 4 to form an electrodeposited copper foil layer 21 comprising only the fine copper particles 9. Hereafter, the manufacturing conditions will be described in the order of the respective types of the tanks continuously arranged in series, however since only the difference was that the formation process of the bulk copper layer 23 was omitted in the example 5 and the rest processes were same as those of the example 5, the description to be duplicated is omitted.

A copper clad laminate was manufactured using the resulting electrodeposited copper foil with carrier 15 obtained in such a manner as the outer layer copper foil of the four-layered board, and the processibility for laser hole formation was investigated. To remove the carrier foil, an alkaline copper-etching solution was used for removing the copper component used for the carrier foil while the damage of the nickel layer being suppressed to the minimum level. After the carrier foil removal, via-hole formation was carried out by laser and the laser radiation conditions were as described in the beginning and a 100-shot laser processing test for via-hole formation was carried out to achieve 100% opening ratio with opening diameter distribution of 110 to 115 μm without any openings smaller than 100 μm diameter. Moreover, on completion of the laser processing, it was confirmed that to manufacture a printed circuit board was possible by removing the nickel-layer using a commercialized peeling solution and forming a bulk copper layer by interlaminar electric connection plating.

### EXAMPLE 8

In this example, an electrodeposited copper foil with carrier 15 according to claim 8 will be described. The surface treating apparatus 2 employed here was that illustrated in FIG. 12 and was a type where an unwound carrier foil 20 was moved in a winding manner through the respective tanks of the surface treating apparatus 2. Here, a deposited foil classified in grade 3 of 18 μm thickness was used as the carrier foil 20 and a nickel layer with the thickness of 1 μm was formed as an additional metal layer 5 in the matte side 8 side to form an electrodeposited copper foil layer 21 with the thickness of 3 μm. Hereafter, the manufacturing conditions will be described in the order of the respective types of the tanks continuously arranged in series, however the treatment procedure was completely same as that of the example 5 and there was no different point.

The difference was that the way of unwinding the carrier foil 20 in the surface treating apparatus 2 was changed and the surface of the copper foil moving in the surface treating apparatus 2 were reversed to those in the case of the example 5. In such a manner an additional metal layer 5 was formed in the matte side 8 side of the carrier foil 20 and fine copper particles were deposited and formed in the shiny side 4.

A copper clad laminate was manufactured using the resulting electrodeposited copper foil with carrier 15 obtained in such a manner as the outer layer copper-foil of the four-layered board, and the processibility for laser hole formation was investigated. To remove the carrier foil, an alkaline copper-etching solution was used for removing the copper component used for the carrier foil while the damage of the nickel layer being suppressed to the minimum level. After the carrier foil removal, via-hole formation was carried out by laser and the laser radiation conditions were as described in the beginning and a 100-shot laser processing test for via-hole formation was carried out to achieve 100% opening ratio with opening diameter distribution of 111 to 114 μm without any openings smaller than 100 μm diameter.

### EXAMPLE 9

In this example, an electrodeposited copper foil with carrier 15 according to claim 9 will be described. The surface treating apparatus 2 employed here was that illustrated in FIG. 12 and was a type where an unwound carrier foil 20 was moved in a winding manner through the respective tanks of the surface treating apparatus 2. Here, a deposited foil classified in grade 3 of 18 μm thickness was used as the carrier foil 20 and a cobalt layer with the thickness of 1 μm was formed as an additional metal layer 5 in the matte side 8 side to form an electrodeposited copper foil layer 21 with the thickness of 3 μm. Hereafter, the manufacturing conditions will be described in the order of the respective types of the tanks continuously arranged in series, however the treatment procedure was completely same as that of the example 6 and there was no different point.

The difference was that the way of unwinding the carrier foil 20 in the surface treating apparatus 2 was changed and the surface of the copper foil moving in the surface treating apparatus 2 were reversed to those in the case of the example 6. In such a manner an additional metal layer 5 was formed in the matte side 8 side of the carrier foil 20 and fine copper particles were deposited and formed in the shiny side 4.

A copper clad laminate was manufactured using the resulting electrodeposited copper foil with carrier 15 obtained in such a manner as the outer layer copper foil of the four-layered board, and the processibility for laser hole formation was investigated. To remove the carrier foil, an alkaline copper-etching solution was used for removing the copper component used for the carrier foil while the damage of the cobalt layer being suppressed to the minimum level. After the carrier foil removal, via-hole formation was carried out by laser and the laser radiation conditions were as described in the beginning and a 100-shot laser processing test for via-hole formation was carried out to achieve 100% opening ratio with opening diameter distribution of 112 to 115 μm without any openings smaller than 100 μm diameter.

### EXAMPLE 10

In this example, an electrodeposited copper foil with carrier 15 according to claim 10 will be described. The surface treating apparatus 2 employed here was that illustrated in FIG. 12 and was a type where an unwound carrier foil 20 was moved in a winding manner through the respective tanks of the surface treating apparatus 2. Here, a deposited foil classified in grade 3 of 18 μm thickness was used as the carrier foil 20 and a nickel layer with the thickness of 1 μm was formed as an additional metal layer 5 in the matte side 8 side to form an electrodeposited copper foil layer 21 comprising only the fine copper particles 9. Hereafter, the manufacturing conditions will be described in the order of the respective types of the tanks continuously arranged in series, however since only the difference was that the formation process of the bulk copper layer 23 was omitted in the example 8 and the rest processes were same as those of the example 8, the description to be duplicated is omitted.

A copper clad laminate was manufactured using the resulting electrodeposited copper foil with carrier 15 obtained in such a manner as the outer layer copper foil of the four-layered board, and the processibility for laser hole formation was investigated. To remove the carrier foil, an alkaline copper-etching solution was used for removing the copper component used for the carrier foil while the damage of the nickel layer being suppressed to the minimum level. After the carrier foil removal, via-hole formation was carried out by laser and the laser radiation conditions were as described in the beginning and a 100-shot laser processing test for via-hole formation was carried out to achieve 100% opening ratio with opening diameter distribution of 112 to 115 μm without any openings smaller than 100 μm diameter. Moreover, on completion of the laser processing, it was confirmed that to manufacture a printed circuit board was possible by removing the nickel layer using a commercialized peeling solution and forming a bulk copper layer by interlaminar electric connection plating.

### EXAMPLE 11

In this example, an electrodeposited copper foil with carrier 15 according to claim 11 will be described. The surface treating apparatus 2 employed here was that illustrated in FIG. 17 and was a type where an unwound carrier foil 20 was moved in a winding manner through the respective tanks of the surface treating apparatus 2. Here, a deposited foil classified in grade 3 of 18 μm thickness was used as the carrier foil 20 and a nickel layer with the thickness of 1 μm was formed as an additional metal layer 5 in the shiny side 4 to form an electrodeposited copper foil layer 21 with the thickness of 3 μm. Hereafter, the manufacturing conditions will be described in the order of the respective types of the tanks continuously arranged in series.

The unwound carrier foil 20 at first entered in an pickling tank 6. The inside of the pickling tank 6 was filled with a diluted sulfuric acid solution of 150 g/l concentration at 30° C. solution temperature and the oils and fats adhering to the carrier foil 20 were removed for immersion time of 30 seconds and the surface oxidized film was removed.

The carrier foil 20 coming out of the pickling tank 6 entered a release layer formation tank 30. The release layer formation tank 22 was filled with an aqueous solution containing CBTA of 5 g/l concentration at the solution temperature of 40° C. and pH of 5. Consequently, while the carrier foil 20 being moved in the solution and immersed for 30 seconds, a release layer 31 was formed on the surface of the carrier foil 20.

After that, an additional metal layer 5 was to be formed on the release layer 31 and a bulk copper layer 23 and fine copper particles 9 were to be formed on the additional metal layer 5 and anti-corrosion treatment and drying were to be carried out. The formation of the additional metal layer 5, formation of the bulk copper layer 23, formation of the fine copper particles 9, the conditions of the anti-corrosion treatment tank 11 and the drying conditions of the drying part 13 were all same as those in the example 5, therefore, the description is omitted.

A copper clad laminate was manufactured using the resulting electrodeposited copper foil with carrier 15 obtained in such a manner as the outer layer copper foil of the four-layered board, and the processibility for laser hole formation was investigated. To remove the carrier foil, the carrier foil was released by manual work to expose the nickel layer. After the carrier foil removal, via-hole formation was carried out by laser and the laser radiation conditions were as described in the beginning and a 100-shot laser processing test for via-hole formation was carried out to achieve 100% opening ratio with opening diameter distribution of 106 to 112 μm without any openings smaller than 100 μm diameter.

### EXAMPLE 12

In this example, an electrodeposited copper foil with carrier 15 according-to claim 12 will be described. The surface treating apparatus 2 employed here was that illustrated in FIG. 17 and was a type where an unwound carrier foil 20 was moved in a winding manner through the respective tanks of the surface treating apparatus 2. Here, a deposited foil classified in grade 3 of 18 μm thickness was used as the carrier foil 20 and a cobalt layer with the thickness of 1 μm was formed as an additional metal layer 5 in the shiny side 4 to form an electrodeposited copper foil layer 21 with the thickness of 3 μm. Hereafter, the manufacturing conditions will be described in the order of the respective types of the tanks continuously arranged in series.

The unwound carrier foil 20 at first entered in an pickling tank 6. The inside of the pickling tank 6 was filled with a diluted sulfuric acid solution of 150 g/l concentration at 30° C. solution temperature and the oils and fats adhering to the carrier foil 20 were removed for immersion time of 30 seconds and the surface oxidized film was removed.

The carrier foil 20 coming out of the pickling tank 6 entered a release layer formation tank 30. The release layer formation tank 22 was filled with an aqueous solution containing CBTA of 5 g/l concentration at the solution temperature of 40° C. and pH of 5. Consequently, while the carrier foil 20 being moved in the solution and immersed for 30 seconds, a release layer 31 was formed on the surface of the carrier foil 20.

After that, an additional metal layer 5 was to be formed on the release layer 31 and a bulk copper layer 23 and fine copper particles 9 were to be formed on the additional metal layer 5 and anti-corrosion treatment and drying were to be carried out. The formation of the additional metal layer 5, formation of the bulk copper layer 23, formation of the fine copper particles 9, the conditions of the anti-corrosion treatment tank 11 and the drying conditions of the drying part 13 were all same as those in the example 6, therefore, the description is omitted.

A copper clad laminate was manufactured using the resulting electrodeposited copper foil with carrier 15 obtained in such a manner as the outer layer copper foil of the four-layered board, and the processibility for laser hole formation was investigated. To remove the carrier foil, the carrier foil was released by manual work to expose the cobalt layer. After the carrier foil removal, via-hole formation was carried out by laser and the laser radiation conditions were as described in the beginning and a 100-shot laser processing test for via-hole formation was carried out to achieve 100% opening ratio with opening diameter distribution of 106 to 112 μm without any openings smaller than 100 μm diameter.

### EXAMPLE 13

In this example, an electrodeposited copper foil with carrier 15 according to claim 13 will be described. The surface treating apparatus 2 employed here was that illustrated in FIG. 17 and was a type where an unwound carrier foil 20 was moved in a winding manner through the respective tanks of the surface treating apparatus 2. Here, a deposited foil classified in grade 3 of 18 μm thickness was used as the carrier foil 20 and a nickel layer with the thickness of 1 μm was formed as an additional metal layer 5 in the shiny side 4 to form an electrodeposited copper foil layer 21 comprising only fine copper particles 9. Hereafter, the manufacturing conditions will be described in the order of the respective types of the tanks continuously arranged in series.

The unwound carrier foil 20 at first entered in an pickling tank 6. The inside of the pickling tank 6 was filled with a diluted sulfuric acid solution of 150 g/l concentration at 30° C. solution temperature and the oils and fats adhering to the carrier foil 20 were removed for immersion time of 30 seconds and the surface oxidized film was removed.

The carrier foil 20 coming out of the pickling tank 6 entered a release layer formation tank 30. The release layer formation tank 22 was filled with an aqueous solution containing CBTA of 5 g/l concentration at the solution temperature of 40° C. and pH of 5. Consequently, while the carrier foil 20 being moved in the solution and immersed for 30 seconds, a release layer 31 was formed on the surface of the carrier foil 20.

After that, an additional metal layer 5 was to be formed on the release layer 31 and fine copper particles 9 were to be formed on the additional metal layer 5 and anti-corrosion treatment and drying were to be carried out. The formation of the additional metal layer 5, formation of the fine copper particles 9, the conditions of the anti-corrosion treatment tank 11 and the drying conditions of the drying part 13 were all same as those in the example 7, therefore, the description is omitted.

A copper clad laminate was manufactured using the resulting electrodeposited copper foil with carrier 15 obtained in such a manner as the outer layer copper foil of the four-layered board, and the processibility for laser hole formation was investigated. To remove the carrier foil, the carrier foil was released by manual work to expose the nickel layer. After the carrier foil removal, via-hole formation was carried out by laser and the laser radiation conditions were as described in the beginning and a 100-shot laser processing test for via-hole formation was carried out to achieve 100% opening ratio with opening diameter distribution of 109 to 114 μm without any openings smaller than 100 μm diameter.

### EXAMPLE 14

In this example, an electrodeposited copper foil with carrier 15 according to claim 14 will be described. The surface treating apparatus 2 employed here was that illustrated in FIG. 17 and was a type where an unwound carrier foil 20 was moved in a winding manner through the respective tanks of the surface treating apparatus 2. Here, a deposited foil classified in grade 3 of 18 μm thickness was used as the carrier foil 20 and a nickel layer with the thickness of 1 μm was formed as an additional metal layer 5 in the matte side 8 side to form an electrodeposited copper foil layer 21 with the thickness of 3 μm. Consequently, the manufacturing processes and the manufacturing conditions were same as those of the example 11 and description will be duplicated and therefore the description is omitted.

The difference was only that the way of unwinding the carrier foil 20 in the surface treating apparatus 2 was changed and the surface of the copper foil moving in the surface treating apparatus 2 were reversed to those in the case of the example 11. In such a manner an additional metal layer 5 was formed in the matte side 8 side of the carrier foil 20 and a bulk copper layer 23 and fine copper particles 9 were formed on the additional metal layer 5 and the anti-corrosion treatment and drying were carried out.

A copper clad laminate was manufactured using the resulting electrodeposited copper foil with carrier 15 obtained in such a manner as the outer layer copper foil of the four-layered board, and the processibility for laser hole formation was investigated. To remove the carrier foil, the carrier foil was released by manual work to expose the nickel layer. After the carrier foil removal, via-hole formation was carried out by laser and the laser radiation conditions were as described in the beginning and a 100-shot laser processing test for via-hole formation was carried out to achieve 100% opening ratio with opening diameter distribution of 106 to 112 μm without any openings smaller than 100 μm diameter.

### EXAMPLE 15

In this example, an electrodeposited copper foil with carrier 15 according to claim 15 will be described. The surface treating apparatus 2 employed here was that illustrated in FIG. 17 and was a type where an unwound carrier foil 20 was moved in a winding manner through the respective tanks of the surface treating apparatus 2. Here, a deposited foil classified in grade 3 of 18 μm thickness was used as the carrier foil 20 and a cobalt layer with the thickness of 1 μm was formed as an additional metal layer 5 in the matte side 8 side to form an electrodeposited copper foil layer 21 with the thickness of 3 μm. Consequently, the manufacturing processes and the manufacturing conditions were same as those of the example 12 and description will be duplicated and therefore the description is omitted.

The difference was only that the way of unwinding the carrier foil 20 in the surface treating apparatus 2 was changed and the surface of the copper foil moving in the surface treating apparatus 2 were reversed to those in the case of the example 11. In such a manner an additional metal layer 5 was formed in the matte side 8 side of the carrier foil 20 and a bulk copper layer 23 and fine copper particles 9 were formed on the additional metal layer 5 and the anti-corrosion treatment and drying were carried out.

A copper clad laminate was manufactured using the resulting electrodeposited copper foil with carrier 15 obtained in such a manner as the outer layer copper foil of the four-layered board, and the processibility for laser hole formation was investigated. To remove the carrier foil, the carrier foil was released by manual work to expose the cobalt layer. After the carrier foil removal, via-hole formation was carried out by laser and the laser radiation conditions were as described in the beginning and a 100-shot laser processing test for via-hole formation was carried out to achieve 100% opening ratio with opening diameter distribution of 106 to 110 μm without any openings smaller than 100 μm diameter.

### EXAMPLE 16

In this example, an electrodeposited copper foil with carrier 15 according to claim 16 will be described. The surface treating apparatus 2 employed here was that illustrated in FIG. 17 and was a type where an unrolled carrier foil 20 was moved in a winding manner through the respective tanks of the surface treating apparatus 2. Here, a deposited foil classified in grade 3 of 18 μm thickness was used as the carrier foil 20 and a cobalt layer with the thickness of 1 μm was formed as an additional metal layer 5 in the shiny side 4 to form an electrodeposited copper foil layer 21 comprising only fine copper particles 9. Consequently, the manufacturing processes and the manufacturing conditions were same as those of the example 13 and description will be duplicated and therefore the description is omitted.

The difference was only that the way of unwinding the carrier foil 20 in the surface treating apparatus 2 was changed and the surface of the copper foil moving in the surface treating apparatus 2 were reversed to those in the case of the example 13. In such a manner an additional metal layer 5 was formed in the matte side 8 side of the carrier foil 20 and a bulk copper layer 23 and fine copper particles 9 were formed on the additional metal layer 5 and the anti-corrosion treatment and drying were carried out.

A copper clad laminate was manufactured using the resulting electrodeposited copper foil with carrier 15 obtained in such a manner as the outer layer copper foil of the four-layered board, and the processibility for laser hole formation was investigated. To remove the carrier foil, the carrier foil was released by manual work to expose the cobalt layer. After the carrier foil removal, via-hole formation was carried out by laser and the laser radiation conditions were as described in the beginning and a 100-shot laser processing test for via-hole formation was carried out to achieve 100% opening ratio with opening diameter distribution of 112 to 115 μm without any openings smaller than 100 μm diameter.

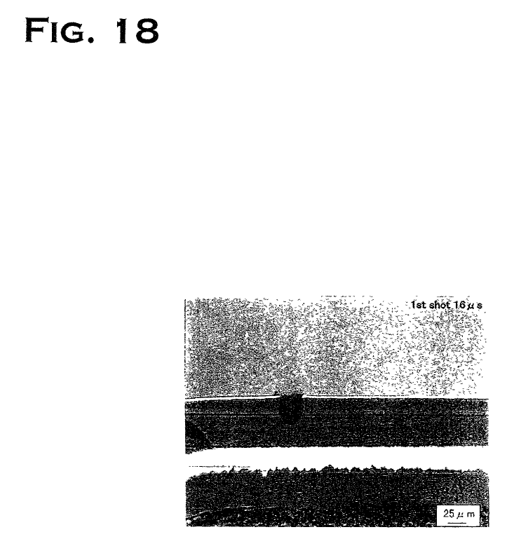

Incidentally, inventors of the invention manufactured a copper clad laminate using an electrodeposited copper foil bearing no additional metal layer for the comparison with the surface treated copper foils and the electrodeposited copper foil with carriers according to the invention and using the same carbon dioxide gas laser and under the same conditions described above, the via-hole formation test was carried out to find complete hole formation was impossible as shown in FIG. 18.

### ADVANTAGES OF THE INVENTION

To use the surface treated copper foils and the electrodeposited copper foil with carriers according to the invention as the outer layer copper foils for copper clad laminates makes it possible to easily form a hole simultaneously in a copper foil of a copper clad laminate and a substrate resin layer without requiring previous peeling of a copper foil in the point where the laser is to be radiated, which is carried out in a conventional conformal mask method. That results in remarkable cost down for manufacturing printed circuit boards and makes manufacture of a circuit substrate with excellent positioning precision possible.

1. A surface treated copper foil for a printed circuit board produced from a copper foil with one side roughened, wherein the copper foil is a surface treated copper foil for processing for laser hole formation and provided with a nickel layer with a thickness of 0.08 to 2.0 μm as an additional metal layer in one side and subjected to a nodular treatment by fine copper particles in another side.

2. A surface treated copper foil for a printed circuit board produced from a copper foil with one side roughened, wherein the copper foil is a surface treated copper foil for processing for laser hole formation and provided with a cobalt layer with a thickness of 0.05 to 3.0 μm as an additional metal layer in one side and subjected to a nodular treatment by fine copper particles in another side.

3. A surface treated copper foil for a printed circuit board produced from an electrodeposited copper foil obtained by electrolysis in a copper electrolytic solution and subjected to nodular treatment in one side, wherein the copper foil is a surface treated copper foil for processing for laser hole formation and provided with a nickel layer with a thickness of 0.05 to 2.0 μm as an additional metal layer in a matte side of the electrodeposited copper foil and subjected to a nodular treatment by fine copper particles in a shiny side.

4. A surface treated copper foil for a printed circuit board produced from an electrodeposited copper foil obtained by electrolysis in a copper electrolytic solution and subjected to nodular treatment in one side, wherein the copper foil is a surface treated copper foil for processing for laser hole formation and provided with a cobalt layer with a thickness of 0.03 to 3.0 μm as an additional metal layer in a matte side of the electrodeposited copper foil and subjected to a nodular treatment by fine copper particles in a shiny side.

5. An electrodeposited copper foil with carrier having a three-layer structure composed of a carrier foil layer, an additional metal layer, and an electrodeposited copper foil layer; wherein a carrier foil is of a metal material having a smooth surface with a roughness (Rz) of 0.05 to less than 4.0 μm, the additional metal layer is a nickel layer with a thickness of 0.08 to 2.0 μm thickness formed in the smooth surface side of the carrier foil, and the electrodeposited copper foil layer composed of a bulk layer and fine copper particles is formed in a surface of the additional metal layer to be an electrodeposited copper foil with carrier for processing for laser hole formation.

6. An electrodeposited copper foil with carrier having a three-layer structure composed of a carrier foil layer, an additional metal layer, and an electrodeposited copper foil layer; wherein a carrier foil is of a metal material having a smooth surface with a roughness (Rz) of 0.05 to less than 4.0 μm, the additional metal layer is a cobalt layer with a thickness of 0.05 to 3.0 μm thickness formed in the smooth surface side of the carrier foil, and the electrodeposited copper foil layer composed of a bulk layer and fine copper particles is formed in a surface of the additional metal layer to be an electrodeposited copper foil with carrier for processing for laser hole formation.

7. An electrodeposited copper foil with carrier having a three-layer structure composed of a carrier foil layer, an additional metal layer, and an electrodeposited copper foil layer; wherein a carrier foil is of a metal material having a smooth surface with a roughness (Rz) of 0.05 to less than 4.0 μm, the additional metal layer is a nickel layer or a cobalt layer with a thickness of 0.03 to 1.0 μm thickness formed in the smooth surface side of the carrier foil, and the electrodeposited copper foil layer comprising only fine copper particles is formed in a surface of the additional metal layer to be an electrodeposited copper foil with carrier for processing for laser hole formation.

8. An electrodeposited copper foil with carrier having a three-layer structure composed of a carrier foil layer, an additional metal layer, and an electrodeposited copper foil layer; wherein a carrier foil is of a metal material having a matte side with a roughness (Rz) of 4.0 to 20.0 μm, the additional metal layer is a nickel layer with a thickness of 0.05 to 2.0 μm thickness formed in a matte side of the carrier foil, and the electrodeposited copper foil layer composed of a bulk layer and fine copper particles is formed in a surface of the additional metal layer to be an electrodeposited copper foil with carrier for processing for laser hole formation.

9. An electrodeposited copper foil with carrier having a three-layer structure composed of a carrier foil layer, an additional metal layer, and an electrodeposited copper foil layer; wherein a carrier foil is of a metal material having a matte side with a roughness (Rz) of 4.0 to 20.0 μm, the additional metal layer is a cobalt layer with a thickness of 0.03 to 3.0 μm thickness formed in the matte side of the carrier foil, and the electrodeposited copper foil layer composed of a bulk layer and fine copper particles is formed in a surface of the additional metal layer to be an electrodeposited copper foil with carrier for processing for laser hole formation.

10. An electrodeposited copper foil with carrier having a three-layer structure composed of a carrier foil layer, an additional metal layer, and an electrodeposited copper foil layer; wherein a carrier foil is of a metal material having a matte side with a roughness (Rz) of 4.0 to 20.0 μm, the additional metal layer is a nickel layer or a cobalt layer with a thickness of 0.03 to 1.0 μm thickness formed in the matte side of the carrier foil, and the electrodeposited copper foil layer comprising only fine copper particles is formed in a surface of the additional metal layer to be an electrodeposited copper foil with carrier for processing for laser hole formation.

11. An electrodeposited copper foil with carrier composed of a release layer formed on a surface of a carrier foil and an additional metal layer and an electrodeposited copper foil layer formed on the release layer, wherein the carrier foil is of a film or a metal material having a smooth surface with a roughness (Rz) of 0.05 to less than 4.0 μm, the release layer is formed using an organic agent or a metal material on the smooth face side of the carrier foil, a nickel layer with a thickness of 0.08 to 2.0 μm thickness is formed as the additional metal layer on a surface of the release layer, and the electrodeposited copper foil layer comprising a bulk layer and fine copper particles is formed in a surface of the additional metal layer to be an electrodeposited copper foil with carrier for processing for laser hole formation.

12. An electrodeposited copper foil with carrier composed of a release layer formed on a surface of a carrier foil and an additional metal layer and an electrodeposited copper foil layer formed on the release layer, wherein the carrier foil is of a film or a metal material having a smooth surface with a roughness (Rz) of 0.05 to less than 4.0 μm, the release layer is formed using an organic agent or a metal material on the smooth face side of the carrier foil, a cobalt layer with a thickness of 0.05 to 3.0 μm thickness is formed as the additional metal layer on a surface of the release layer, and the electrodeposited copper foil layer comprising a bulk layer and fine copper particles is formed in a surface of the additional metal layer to be an electrodeposited copper foil with carrier for processing for laser hole formation.

13. An electrodeposited copper foil with carrier composed of a release layer formed on a surface of a carrier foil and an additional metal layer and an electrodeposited copper foil layer formed on the release layer, wherein the carrier foil is of a film or a metal material having a smooth surface with a roughness (Rz) of 0.05 to less than 4.0 μm, the release layer is formed using an organic agent or a metal material on the smooth face side of the carrier foil, a nickel layer or a cobalt layer with a thickness of 0.03 to 1.0 μm thickness is formed as the additional metal layer on the surface of the release layer, and the electrodeposited copper foil layer comprising only fine copper particles is formed in the surface of the additional metal layer to be an electrodeposited copper foil with carrier for processing for laser hole formation.

14. An electrodeposited copper foil with carrier composed of a release layer formed on a surface of a carrier foil and an additional metal layer and an electrodeposited copper foil layer formed on the release layer, wherein the carrier foil is of a film or a metal material having a roughened face with a roughness (Rz) of 4.0 to 20.0 μm, the release layer is formed using an organic agent or a metal material on the roughened face side of the carrier foil, a nickel layer with a thickness of 0.05 to 2.0 μm thickness is formed as the additional metal layer on a surface of the release layer, and the electrodeposited copper foil layer comprising a bulk layer and fine copper particles is formed in the surface of the additional metal layer to be an electrodeposited copper foil with carrier for processing for laser hole formation.

15. An electrodeposited copper foil with carrier composed of a release layer formed on a surface of a carrier foil and an additional metal layer and an electrodeposited copper foil layer formed on the release layer, wherein the carrier foil is of a film or a metal material having a roughened face with a roughness (Rz) of 4.0 to 20.0 μm, the release layer is formed using an organic agent or a metal material on the roughened face side of the carrier foil, a cobalt layer with a thickness of 0.03 to 3.0 μm is formed as the additional metal layer on a surface of the release layer, and the electrodeposited copper foil layer comprising a bulk layer and fine copper particles is formed in a surface of the additional metal layer to be an electrodeposited copper foil with carrier for processing for laser hole formation.

16. An electrodeposited copper foil with carrier composed of a release layer formed on a surface of a carrier foil and an electrodeposited copper foil layer formed on the release layer, wherein the carrier foil is of a film or a metal material having a roughened face with a roughness (Rz) of 4.0 to 20.0 μm, the release layer is formed using an organic agent or a metal material on the roughened face side of the carrier foil, a nickel layer or a cobalt layer with a thickness of 0.03 to 1.0 μm thickness is formed as the additional metal layer on a surface of the release layer, and the electrodeposited copper foil layer comprising only fine copper particles is formed in a surface of the additional metal layer to be an electrodeposited copper foil with carrier for processing for laser hole formation.

17. The electrodeposited copper foil with carrier for processing for laser hole formation as claimed in claim 11 to claim 16, wherein the organic agent to be employed for the release layer is one or more compounds selected from nitrogen-containing organic compounds, sulfur-containing organic compounds, and carboxylic acids.

18. The electrodeposited copper foil with carrier for processing for laser hole formation as claimed in claim 11 to claim 16, wherein the release layer is formed by applying one of organic agent or a mixture of two or more organic agents selected from nitrogen-containing organic compounds, sulfur-containing organic compounds, and carboxylic acids repeatedly a plurality of times.

19. The electrodeposited copper foil with carrier for processing for laser hole formation as claimed in claim 11 to claim 16, wherein the release layer is formed by reciprocally and repeatedly applying two or more organic agents selected from nitrogen-containing organic compounds, sulfur-containing organic compounds, and carboxylic acids.

20. The electrodeposited copper foil with carrier for processing for laser hole formation as claimed in any one of claim 11 to claim 19, wherein the release layer is of an organic film with a thickness of 1 nm to 1 μm.

21. The electrodeposited copper foil with carrier as claimed in any one of claim 5, claim 6, claim 7, claim 11, claim 12, and claim 13, wherein the carrier foil is an electrodeposited copper foil having a matte side with a roughness (Rz) of 0.05 μm to less than 4.0 μm.

22. The electrodeposited copper foil with carrier for processing for laser hole formation as claimed in any one of claim 8, claim 9, claim 10, claim 14, claim 15, and claim 16, wherein the carrier foil is an electrodeposited copper foil having a matte side with a roughness (Rz) of 4.0 μm to 20.0 μm.

23. A manufacturing method for an electrodeposited copper foil with carrier comprising steps of unwinding a carrier foil rolled in a roll state in one direction and subjecting the carrier foil to electrodeposited copper foil layer formation processes properly equipped with water-rinsing treatment tanks by passing the carrier foil respectively through an pickling tank, a release layer formation tank using an organic agent, a formation tank for forming a bulk copper layer to be the electrodeposited copper foil layer, a surface nodular treatment tank for forming fine copper particles on a surface of the bulk copper layer, an anti-corrosion treatment tank, and a drying part to continuously form the release layer of the organic agent and the electrodeposited copper foil layer on the carrier foil.

24. A copper clad laminate obtained using the surface treated copper foil for processing for laser hole formation as claimed in claim 1 to claim 4.

25. A copper clad laminate obtained using the electrodeposited copper foil with carrier for processing for laser hole formation as claimed in claim 5 to claim 22.
